(19) United States
(12) Patent Application Publication
(10) Pub. No.: US 2026/0021842 A1
(43) Pub. Date: Jan. 22, 2026

(54) Child basket, child stroller, and child car safety seat

(71) Applicant: GOODBABY CHILD PRODUCTS CO., LTD., Kunshan, JIangsu (CN)

(72) Inventors: Bo FENG, Suzhou, Jiangsu (CN); Junma WANG, Suzhou, Jiangsu (CN); Jianwei ZHENG, Suzhou, Jiangsu (CN)

(21) Appl. No.: 18/875,355

(22) PCT Filed: Jun. 20, 2023
(86) PCT No.: PCT/CN2023/101307

§ 371 Date: Dec. 16, 2024

(30) Foreign Application Priority Data
Jun. 21, 2022 (CN) 202210705285.3
Jun. 21, 2022 (CN) 202210706225.3
Jun. 21, 2022 (CN) 202221560446.6
Jun. 21, 2022 (CN) 202221560447.0

(51) Int. Cl. B62B 7/14; B60N 2/28; B62B 7/08; B62B 9/12; B62B 9/20

(52) U.S. Cl. CPC B62B 7/145; B60N 2/2845; B60N 2/2848; B62B 7/083; B62B 9/12; B62B 9/203

(57) ABSTRACT

A child basket includes a seat body; a handle movably connected with the seat body through a joint; a safety mechanism connected with the joint; a locking mechanism comprising a locking member slidably disposed within the joint; when both the safety mechanism and the locking mechanism are in a locking configuration, the safety mechanism blocks the movement path of the locking member; when the safety mechanism is pushed by an exerted force, the safety mechanism moves away from the movement path of the locking member to enable the locking member to unlock, thereby the handle is rotatable with respect to the seat body around a handle shaft with an axis extending along the left-right direction of the seat body.

### CROSS REFERENCE TO RELATED APPLICATIONS

This application claims the benefit of PCT Application No. PCT/CN2023/101307, filed on Jun. 20, 2023, which claims filing benefit of Chinese filing No. CN2022107052853, CN2022215604470, CN2022107062253 and CN2022215604466 having a filing date of Jun. 21, 2022, all of which are incorporated herein by reference.

### TECHNICAL FIELD

The present disclosure relates to children's articles, and particularly relates to a child basket, a child stroller, and a child car safety seat.

### BACKGROUND ART

To meet the needs of parents and children, some child baskets may be designed to be used in a variety of ways. For example, a child basket may be mounted on a child stroller or child car safety seat. The handle of the child basket may act as a push handle for the stroller when mounted on the child stroller for the user to push. In addition, the child basket can be carried separately, in which case the handle acts as a handle for the user to carry. At present, the handle of some child basket has the functions of contracting and reversing at the same time, which requires at least two sets of locking mechanisms on the handle, namely, a locking mechanism for adjusting the length of the handle and a locking mechanism for controlling the rotation of the handle (for switching the angle of the handle to make it easy to push or carry). The two sets of locking mechanisms are mostly configured to work independently. However, when the child basket is required to be switched to be carried for use or switched to be mounted on a child stroller or a child car safety seat for use, both the is required to be controlled to adjust the length of the handle and the is required to be controlled to control the rotation of the handle bar, which is inconvenient for operation.

### SUMMARY OF THE INVENTION

In an aspect, the present disclosure relates to a child basket.

In another aspect, the present disclosure relates to a child stroller.

In another aspect, the present disclosure relates to a child car safety seat.

In a first aspect, the present disclosure provides a child basket including a seat body and a telescopic handle, wherein the handle includes an upper handle bar, a lower handle bar and a latching mechanism:
the latching mechanism has a locking configuration and an unlocking configuration:
when the latching mechanism is in the locking configuration, the handle is locked at an extended position or a retracted position: when the latching mechanism is in the unlocking configuration, the handle is switchable between the extended position and the retracted position: the upper handle bar slides with respect to the lower handle bar such that the handle extends/retracts:
a joint is disposed between a lower end portion of the lower handle bar and the seat body, wherein the joint includes a handle shaft, a locking mechanism and a safety mechanism:
the axis of the handle shaft extends along the left-right direction of the seat body: the locking mechanism and the safety mechanism both have a locking configuration and an unlocking configuration: when the safety mechanism is in the unlocking configuration, the locking mechanism is able to switch from the locking configuration to the unlocking configuration when the lower end portion of the lower handle bar and the seat body is rotatable around the handle shaft: when the safety mechanism is in the locking configuration, the locking mechanism is unable to switch from the locking configuration to the unlocking configuration when the lower end portion of the lower handle bar and the seat body is locked:
the handle has at least a push position and a basket position with respect to the seat body: the handle is in the push position or the basket position when the handle rotates to different angles with respect to the seat body:
wherein, in condition that the handle is in the push position and when the latching mechanism is in the unlocking configuration and the upper handle bar slides downwardly with respect to the lower handle bar to the retracted position, the upper handle bar triggers the safety mechanism to switch from the locking configuration to the unlocking configuration to allow the locking mechanism to switch from the locking configuration to the unlocking configuration; and

The latching mechanism is switched from the unlocking configuration to the locking configuration with the handle also switched from the push position to the basket position when the handle rotates with respect to the seat body about the handle shaft.

In some embodiments, the locking mechanism includes:
a first engaging member fixedly disposed on the seat body:
a second engaging member fixedly disposed at the lower end portion of the lower handle bar;
a locking member disposed between the first engaging member and the second engaging member:
an elastic member, wherein the elastic member abuts against the locking member: the elastic member is configured to drive the locking member to slide along the axis of the handle shaft, so that the locking member has a tendency to lock with respect to both the first engaging member and the second engaging member at the same time:
when the locking mechanism is in the locking configuration, the locking member is locked with respect to the first engaging member and the second engaging member respectively: when the locking mechanism is in the unlocking configuration, the locking member is locked with respect to only one of the first engaging member and the second engaging member, and is disengaged from the other one of the first engaging member and the second engaging member: when the locking member is moved, the locking mechanism is switched between the locking configuration and the unlocking configuration; and
the safety mechanism is configured to lock movement of the locking member in the locking configuration and allow movement of the locking member in the unlocking configuration.

In some embodiments, the first engaging member is provided with a first groove radially recessed and extended along the axis of the handle shaft:
the second engaging member is provided with a second groove radially recessed and extended along the axis of the handle shaft:
the locking member is connected with a button where the joint is exposed: the locking member is slidably disposed along the axis direction of the handle shaft, a radially extended protrusion is provided on the locking member, and the protrusion extends along the axis of the handle shaft:
when the locking mechanism is in the locking configuration, the protrusion is inserted into the first groove and the second groove respectively, so that the locking member is simultaneously engaged with the first engaging member and the second engaging member: when the locking mechanism is in the unlocking configuration, the protrusion is disengaged from one of the first groove and the second groove and only inserted into the other one of the first groove and the second groove, so that the locking member is engaged with only one of the first engaging member and the second engaging member; when the button is pressed to drive the locking member to slide axially, the locking mechanism is switched between the locking configuration and the unlocking configuration;
the safety mechanism is a catch piece: when both the safety mechanism and the locking mechanism are in the locking configuration, the catch piece blocks the movement path of the locking member: when the safety mechanism is in the unlocking configuration, the catch piece moves away from the movement path of the locking member; and the movement path of the locking member refers to a sliding path of the locking member when the locking mechanism is switched from the locking configuration to the unlocking configuration.

In some embodiments, when the upper handle bar slides downwardly with respect to the lower handle bar to the retracted position, the upper handle bar pushes the catch piece away from the movement path of the locking member.

In some embodiments, the latching mechanism includes a locking pin and a locking hole coordinated with the locking pin: one of the locking pin and the locking hole is disposed on the upper handle bar and the other one of the locking pin and the locking hole is disposed on the lower handle bar; when the f latching mechanism is in the locking configuration, the locking pin is inserted into the locking hole: when the latching mechanism is in the unlocking configuration, the locking pin is disengaged from the locking hole: when the latching mechanism is switched between the locking configuration and the unlocking configuration, the locking pin slides with respect to the lower handle bar.

In some embodiments, the latching mechanism includes a locking pin disposed on the lower handle bar, a spring, and a locking hole provided on a lower portion of the upper handle bar: a sliding direction of the locking pin is perpendicular to a sliding direction of the upper handle bar with respect to the lower handle bar; and the spring is disposed between the locking pin and the lower handle bar to exert a force biasing the locking pin to move away from the locking hole.

In some embodiments, the child basket further includes a locking coordination mechanism configured to switch the latching mechanism from the unlocking configuration to the locking configuration with the handle also switched from the push position to the basket position when the handle rotates with respect to the seat body about the handle shaft.

In some embodiments, the locking coordination mechanism includes a guiding inclined surface disposed on a side surface of the seat body: the guiding inclined surface intersects with the axis of the handle shaft; and when the handle switches from the push position to the basket position, the guiding inclined surface pushes the locking pin to slide towards the locking hole.

In some embodiments, the guiding inclined surface is gradually inclined from bottom to top in a direction away from the handle.

In some embodiments, the locking pin has a locking end portion and a driving end portion, and the locking end portion is configured to insert into the locking hole; and when the handle switches from the push position to the basket position, the driving end portion abuts against and slides along the guiding inclined surface and the guiding inclined surface is gradually getting closer to the locking hole.

In some embodiments, a locking plane is disposed on a side of the seat body adjacent to the joint; and the axis of the handle shaft is perpendicular to the locking plane, and the guiding inclined surface intersects with the locking plane:

the handle also has an anti-tilt position and a safety seat position; and when the handle is switched between the basket position and the anti-tilt position or the safety seat position, the driving end portion presses against the locking plane and is slidably connected therewith, so that the latching mechanism is in the locking configuration.

In some embodiments, the latching mechanism includes:
a locking pin disposed in a lower portion of the upper handle bar and slidably connected to the upper handle bar, wherein the sliding direction of the locking pin is perpendicular to the sliding direction of the upper handle bar with respect to the lower handle bar, the locking pin has a locking end portion and a driving end portion:
an upper handle bar locking hole provided on a side wall of the upper handle bar adjacent to the locking end portion:
a lower handle bar locking hole provided on a lower side wall of the lower handle bar; a spring disposed between the upper handle bar and the locking pin:
wherein when the latching mechanism is in the locking configuration, the locking end portion is inserted into the upper handle bar locking hole and the lower handle bar locking hole: the locking pin is disengaged from the lower handle bar locking hole when the latching mechanism is in the unlocking configuration: when the latching mechanism is switched between the locking configuration and the unlocking configuration, the locking pin slides along the upper handle bar; and the spring exerts a force biasing the locking pin to switch into the unlocking configuration.

In some embodiments, the child basket further includes a locking coordination mechanism including a slider disposed in a lower end portion of the upper handle bar which is slidable along a sliding direction of the upper handle bar with respect to the lower handle bar, an upper end portion of the slider is in contact with the driving end portion via a first guiding inclined surface disposed on at least one of the upper end portion of the slider and the driving end portion, so that the sliding direction of the slider is perpendicular to the sliding direction of the locking pin, and the lower end portion of the slider protrudes downwards from the lower end portion of the upper handle bar.

In some embodiments, the locking coordination mechanism further includes a second guiding inclined surface disposed on a side surface of the seat body, and an angle is formed between the second guiding inclined surface and the sliding direction of the slider: when the handle is switched from the push position to the basket position, the lower end portion of the slider presses against the second guiding inclined surface and is slidably connected therewith: the second guiding inclined surface pushes the slider to slide upwards the upper end portion of the slider pushes the driving end portion to slide the locking pin, thereby the locking end portion moves towards the lower handle bar locking hole.

In some embodiments, a circumferential surface is provided on a side of the seat body adjacent to the joint, the center of the circumferential surface is on the axis of the handle shaft and the second guiding inclined surface is a tangent plane on the circumferential surface.

In some embodiments, the handle further includes an anti-tilt position and a safety seat position: when the handle is switched between the basket position and the anti-tilt position or the safety seat position, the lower end portion of the slider presses against the circumferential surface and is slidably connected therewith; and the upper end portion of the slider continuously presses against the locking pin to keep the latching mechanism in the locking configuration.

In some embodiments, two of the first guiding inclined surfaces are disposed on the upper end of the slider and the driving end portion respectively, the first guiding inclined surface on the upper end of the slider is in face-to-face mating and sliding contact with the first guiding inclined surface on the driving end portion.

In some embodiments, the latching mechanism includes:
a locking pin, wherein the locking pin is pivotally connected to the lower portion of the upper handle bar via a locking pin shaft, the locking pin at both sides of the locking pin shaft are respectively referred to as a locking end portion and a driving end portion;
an upper handle bar locking hole provided on a side wall of the upper handle bar adjacent to the locking end:
a lower handle bar locking hole provided on a lower side wall of the lower handle bar;
a spring disposed between the upper handle bar and the locking pin:
wherein when the latching mechanism is in the locking configuration, the locking end portion is inserted into the upper handle bar locking hole and the lower handle bar locking hole: the locking pin is disengaged from the lower handle bar locking hole when the latching mechanism is in the unlocking configuration: when the latching mechanism is switched between the locking configuration and the unlocking configuration, the locking pin rotates around the locking pin shaft; and the spring exerts a force biasing the locking pin to switch into the unlocking configuration.

In some embodiments, the child basket further includes a locking coordination mechanism including a slider disposed on a lower end portion of the upper handle bar which is slidable along a length direction of the upper handle bar: an upper portion of the slider abuts against the driving end portion, and a lower end portion of the slider protrudes downwards from the lower end portion of the upper handle bar; and the spring is arranged between the upper handle bar and the locking pin, or/and the spring is arranged between the upper handle bar and the slider.

In some embodiments, the locking coordination mechanism further includes a guiding inclined surface arranged on a side surface of the seat body, an angle is formed between the guiding inclined surface and the sliding direction of the slider: when the handle is switched from the push position to the basket position, the lower end portion of the slider presses against the guiding inclined surface and is slidably connected therewith; the guiding inclined surface pushes the slider to slide upwards; and the upper portion of the slider pushes the driving end portion upwards so that the locking pin rotates around the locking pin shaft, thereby the locking end portion moves towards the lower handle bar locking hole.

In some embodiments, a circumferential surface is provided on a side of the seat body adjacent to the joint: the center of the circumferential surface is the axis of the handle shaft; and the guiding inclined surface is a tangent plane on the circumferential surface. In some embodiments, the handle further includes an anti-tilt position and a safety seat position: when the handle is switched between the basket position and the anti-tilt position or the safety seat position, the lower end portion of the slider presses against the circumferential surface and is slidably connected therewith; and the upper end portion of the slider continuously presses against the locking pin to keep the latching mechanism in the locking configuration.

In some embodiments, the spring includes a first spring disposed between the upper handle bar and the locking pin and a second spring disposed between the upper handle bar and the slider.

In some embodiments, the latching mechanism includes:
a locking pin disposed in a lower portion of the upper handle bar and slidably connected to the upper handle bar, wherein the sliding direction of the locking pin is perpendicular to the sliding direction of the upper handle bar with respect to the lower handle bar: the locking pin has a locking portion and a driving portion thereon:
an upper handle bar locking hole provided on a side wall of the upper handle bar adjacent to the locking portion:
a lower handle bar locking hole provided on a lower side wall of the lower handle bar; a spring disposed between the upper handle bar and the locking pin:
wherein when the latching mechanism is in the locking configuration, the locking portion is inserted into the upper handle bar locking hole and the lower handle bar locking hole: the locking portion is disengaged from the lower handle bar locking hole when the latching mechanism is in the unlocking configuration: when the latching mechanism is switched between the locking configuration and the unlocking configuration, the locking pin slides along the upper handle bar; and the spring exerts a force biasing the locking pin to switch into the locking configuration.

In some embodiments, the child basket further includes a locking coordination mechanism including a slider slidably disposed in a lower end portion of the upper handle bar in a sliding direction of the upper handle bar with respect to the lower handle bar: the lower end portion of the slider protrudes downwards from the lower end portion of the upper handle bar:
when the latching mechanism is in the locking configuration, the upper portion of the slider blocks the movement path of the locking pin: when the latching mechanism is in the unlocking configuration, the upper portion of the slider is away from the movement path of the locking pin; and the movement path of the locking member refers to a sliding path of the locking pin when the latching mechanism is switched from the locking configuration to the unlocking configuration.

In some embodiments, the locking coordination mechanism further includes a first guiding inclined surface disposed on a side surface of the seat body, an angle is formed between the first guiding inclined surface and a sliding direction of the slider: when the handle switches from the push position to the basket position, the lower end portion of the slider presses against the first guiding inclined surface and is slidably connected therewith, and the first guiding inclined surface pushes the slider to slide upwards, so that the upper portion of the slider blocks the movement path of the locking pin to keep the locking portion being inserted into the lower handle bar locking hole.

In some embodiments, a circumferential surface is provided on a side of the seat body adjacent to the joint: the center of the circumferential surface is on the axis of the handle shaft; and the first guiding inclined surface is a tangent plane on the circumferential surface.

In some embodiments, the handle further includes an anti-tilt position and a safety seat position: when the handle is switched between the basket position and the anti-tilt position or the safety seat position, the lower end portion of the slider presses against the circumferential surface and is slidably connected therewith: so that the upper portion of the slider continuously blocks the movement path of the locking pin.

In some embodiments, the locking pin is provided with an insertion hole, when the latching mechanism is in the locking configuration, the upper portion of the slider is inserted into the insertion hole: when the latching mechanism is in the unlocking configuration, the upper portion of the slider is disengaged from the insertion hole.

In some embodiments, a traction device is disposed in the upper handle bar: an unlocking guide block is connected to the traction device, the unlocking guide block is at least partially inserted into the insertion hole, a movable portion is disposed in the handle, one side of the unlocking guide block is in contact with the movable portion via a third guiding inclined surface: an angle is formed between the third guiding inclined surface and the sliding direction of the locking pin: the third guiding inclined surface is disposed on one side of the movable portion or/and the unlocking guide block: when the latching mechanism is in the locking configuration, the upper portion of the slider is disposed between the first locking pin and the other side of the unlocking guide block; and when the upper portion of the slider is disengaged from the insertion hole, the traction device pulls the unlocking guide block, and the third guiding inclined surface pushes the movable portion to slide in a direction away from the lower handle bar locking hole, so that the latching mechanism is in the unlocking configuration.

In a second aspect, the present disclosure provides a child stroller including a frame and wheels disposed below the frame, the frame being provided with the above-described child basket.

In a third aspect, the present disclosure includes a child car safety seat including a frame, wheels disposed below the frame, and a base, the frame having an unfolded configuration and a folded configuration; and when the frame is in folded configuration, the frame is mounted on the base and the frame is provided with a child basket.

In a fourth aspect, the present disclosure provides another child car safety seat including a base and a child basket disposed on the base, wherein the child basket is the child basket described above.

In the child basket of the present disclosure, the handle has a push position and a basket position and can be switched between the two positions. The length of the handle can also be adjusted. The latching mechanism for controlling the extension and retraction of the handle can be automatically locked during the process that the upper handle bar slides with respect to the lower handle bar to the retracted state and the handle bar rotates, so that the relative sliding between the upper handle bar and the lower handle bar cannot occur and the length is adjusted while the positions are switched, avoiding the problem that the latching mechanism and the locking mechanism are required to be separately controlled to be unlocked. It is convenient for use.

### BRIEF DESCRIPTION OF THE DRAWINGS

FIG. 1 is a schematic side view of a child basket in a forward push position in a first embodiment of the present disclosure (the upper handle bar and the lower handle bar have not yet slid relative to each other, the length of the handle is in the longest state, and the latching mechanism is in a locking configuration);

FIG. 2 is a cross-sectional view taken along the line A-A in FIG. 1:

FIG. 3 is a partially enlarged view at A in FIG. 2:

FIG. 4 is a schematic side view of the child basket in a forward push position in the first embodiment of the present disclosure (the upper handle bar and the lower handle bar slide relative to each other, and the latching mechanism is in an unlocking configuration):

FIG. 5 is a cross-sectional view taken along the line B-B in FIG. 4:

FIG. 6 is a partially enlarged view at B in FIG. 5:

FIG. 7 is a cross-sectional view taken along the line C-C in FIG. 4:

FIG. 8 is a partially enlarged view at C in FIG. 7:

FIG. 9 is a schematic side view of a child basket in the basket position according to the first embodiment of the present disclosure:

FIG. 10 is a cross-sectional view taken along the direction D-D in FIG. 9:

FIG. 11 is a partially enlarged view at D in FIG. 10;

FIG. 12 is a sectional view taken along the line E-E in FIG. 9:

FIG. 13 is a partially enlarged view at E in FIG. 12:

FIG. 14 is a schematic cross-sectional view of the child basket when a locking mechanism is in an unlocking configuration after the button is pressed in the first embodiment of the present disclosure:

FIG. 15 is a schematic side view of the child basket between a basket position and a push position according to an embodiment of the present disclosure:

FIG. 16 is a schematic side view of a child basket in a safety seat position according to an embodiment of the present disclosure:

FIG. 17 is a schematic side view of the child basket mounted on the frame of the child stroller according to the first embodiment of the present disclosure (forward stroller configuration):

FIG. 18 is a schematic side view of a child basket mounted to a frame of a child stroller according to an embodiment of the present disclosure (inverted stroller configuration):

FIG. 19 is a schematic side view of a child basket mounted to a child stroller frame according to an embodiment of the present disclosure:

FIG. 20 is a schematic side view of a child basket mounted on a frame of a child car safety seat according to an embodiment of the present disclosure:

FIG. 21 is a schematic side view of a child basket in a forward push position in a second embodiment of the present disclosure (the upper handle bar and the lower handle bar have not yet slid relative to each other, the length of the handle is in the longest state, and the latching mechanism is in a locking configuration):

FIG. 22 is a cross-sectional view taken along the line A-A in FIG. 21:

FIG. 23 is a partially enlarged view at A in FIG. 22:

FIG. 24 is a schematic cross-sectional view of the child basket in a forward push position in the second embodiment of the present disclosure (the upper handle bar and the lower handle bar slide relative to each other, and the latching mechanism is in an unlocking configuration):

FIG. 25 is a partially enlarged view at B in FIG. 24:

FIG. 26 is a cross-sectional view taken along the line B-B in FIG. 24:

FIG. 27 is a partially enlarged view at C in FIG. 26:

FIG. 28 is a schematic cross-sectional view of the child basket in a basket position according to a second embodiment of the present disclosure:

FIG. 29 is a partially enlarged view at D in FIG. 28:

FIG. 30 is a schematic cross-sectional view of a child basket between a basket position and a push position according to the second embodiment of the present disclosure:

FIG. 31 is a partially enlarged view at E of FIG. 30;

FIG. 32 is a schematic cross-sectional view of a child basket in a safety seat position according to the second embodiment of the present disclosure:

FIG. 33 is a partially enlarged view at F of FIG. 32:

FIG. 34 is a schematic side view of the child basket mounted on the frame of the child stroller in the second embodiment of the present disclosure (forward stroller state):

FIG. 35 is a schematic side view of the child basket mounted on the frame of the child stroller in the second embodiment of the present disclosure (inverted stroller state);

FIG. 36 is a schematic side view (folded state) of the child basket mounted on the frame of the child stroller in the second embodiment of the present disclosure:

FIG. 37 is a schematic side view of a child basket mounted on a frame of a child car safety seat in a second embodiment of the present disclosure:

FIG. 38 is a schematic side view of a child basket in a forward push position in a third embodiment of the present disclosure (the upper handle bar and the lower handle bar have not yet slid relative to each other, the length of the handle is in the longest state, and the latching mechanism is in a locking configuration):

FIG. 39 is a cross-sectional view taken along the line A-A in FIG. 38:

FIG. 40 is a partially enlarged view at A in FIG. 39:

FIG. 41 is a schematic side view of the child basket in a forward push position in the third embodiment of the present disclosure (the upper handle bar and the lower handle bar slide relative to each other, and the latching mechanism is in an unlocking configuration):

FIG. 42 is a partially enlarged view at B in FIG. 41:

FIG. 43 is a cross-sectional view taken along the line B-B in FIG. 41:

FIG. 44 is a partially enlarged view at C in FIG. 43:

FIG. 45 is a schematic side view of a child basket in the basket position according to the third embodiment of the present disclosure:

FIG. 46 is a partially enlarged view at D in FIG. 45:

FIG. 47 is a schematic side view of the child basket between a basket position and a push position according to the third embodiment of the present disclosure:

FIG. 48 is a partially enlarged view at E in FIG. 47:

FIG. 49 is a schematic side view of a child basket in a safety seat position according to the third embodiment of the present disclosure:

FIG. 50 is a partially enlarged view at F in FIG. 49:

FIG. 51 is a schematic side view of the child basket mounted on the frame of the child stroller according to the third embodiment of the present disclosure (forward stroller configuration):

FIG. 52 is a schematic side view of a child basket mounted to a frame of a child stroller according to the third embodiment of the present disclosure (inverted stroller configuration);

FIG. 53 is a schematic side view (folded state) of the child basket mounted on the frame of the child stroller according to the third embodiment of the present disclosure:

FIG. 54 is a schematic side view of a child basket mounted on a frame of a child car safety seat according to the third embodiment of the present disclosure:

FIG. 55 is a schematic side view of a child basket in a forward push position in a fourth embodiment of the present disclosure (the upper handle bar and the lower handle bar have not yet slid relative to each other, the length of the handle is in the longest state, and the latching mechanism is in a locking configuration):

FIG. 56 is a cross-sectional view taken along the line A-A in FIG. 55:

FIG. 57 is a partially enlarged view at A in FIG. 56:

FIG. 58 is a schematic side view of the child basket in a forward push position in the fourth embodiment of the present disclosure (the upper handle bar and the lower handle bar slide relative to each other, and the latching mechanism is in an unlocking configuration):

FIG. 59 is a partially enlarged view at B in FIG. 58:

FIG. 60 is a cross-sectional view taken along the line B-B in FIG. 58:

FIG. 61 is a partially enlarged view at C in FIG. 60:

FIG. 62 is a schematic side view of a child basket in a basket position according to the fourth embodiment of the present disclosure:

FIG. 63 is a partially enlarged view at D in FIG. 62:

FIG. 64 is a schematic side view of the child basket between a basket position and a push position according to the fourth embodiment of the present disclosure:

FIG. 65 is a partially enlarged view at E in FIG. 64:

FIG. 66 is a schematic side view of a child basket in a safety seat position according to the fourth embodiment of the present disclosure:

FIG. 67 is a partially enlarged view at F in FIG. 66:

FIG. 68 is a schematic side view of the child basket mounted on the frame of the child stroller according to the fourth embodiment of the present disclosure (forward stroller configuration):

FIG. 69 is a schematic side view of a child basket mounted to a frame of a child stroller according to the fourth embodiment of the present disclosure (inverted stroller configuration):

FIG. 70 is a schematic side view (folded state) of the child basket mounted on the frame of the child stroller according to the fourth embodiment of the present disclosure; and

FIG. 71 is a schematic side view of a child basket mounted on a frame of a child car safety seat according to the fourth embodiment of the present disclosure;

In the drawings, 11, child basket: 12, seat body: 13, handle: 14, upper handle bar: 15, lower handle bar: 16, latching mechanism: 17, joint: 18, handle shaft: 19, locking mechanism: 110, safety mechanism: 111, axis: 112, first engaging member: 113, second engaging member: 114, locking member: 115, elastic member: 116, first groove: 117, second groove: 118, button: 119, protrusion: 120, catch piece: 121, locking pin: 122, spring: 123, locking hole: 124, guiding inclined surface: 125, locking end portion: 126, driving end portion: 127, locking plane: 128, frame: 129, wheel: 130, base: 21, child basket: 22, seat body: 23, handle: 24, upper handle bar: 25, lower handle bar: 26, latching mechanism: 27, joint: 28, handle shaft: 29, locking mechanism: 210, safety mechanism: 211, axis: 212, locking pin: 213, locking end portion: 214, driving end portion: 215, upper handle rod locking hole: 216, lower handle bar locking hole: 217, slider: 218, second guiding inclined surface: 219, spring: 220: first guiding inclined surface: 221, circumferential surface: 222, first engaging member: 223, second engaging member: 224, locking member: 225, elastic member: 226, first groove: 227, second groove: 228, button: 229, protrusion: 230, catch piece: 231, frame: 232, wheel; 233, base: 31, child basket: 32, seat body: 33, handle: 34, upper handle bar: 35, lower handle bar: 36, latching mechanism: 37, joint: 38, handle shaft: 39, locking mechanism; 310, safety mechanism: 311, axis: 312, locking pin: 313, locking end portion: 314, driving end portion: 315, upper handle bar locking hole: 316, lower handle bar locking hole: 317, slider: 318, spring: 319, guiding inclined surface: 320, circumferential surface: 321, first spring: 322, second spring: 323, first engaging member: 324, second engaging member: 325, locking member: 326, elastic member: 327, first groove: 328, second groove: 329, button: 330, protrusion: 331, catch piece: 332, frame: 333, wheel below the frame: 334, base: 41, child basket: 42, seat body: 43, handle: 44, upper handle bar: 45, lower handle bar: 46, latching mechanism: 47, joint: 48, handle shaft: 49, locking mechanism: 410, safety mechanism: 411, axis: 412, locking pin: 413, locking portion: 414, movable portion: 415, upper handle bar locking hole: 416, lower handle bar locking hole: 417, slider: 418, spring: 419, first guiding inclined surface: 420, circumferential surface: 421, insertion hole: 422, traction device: 423, unlocking guide block: 424, third guiding inclined surface: 425, first engaging member: 426, second engaging member: 427, locking member: 428, elastic member: 429, first groove: 430, second groove: 431, button: 432, protrusion: 433, catch piece: 434, frame: 435, wheel; 436, base.

### DETAILED DESCRIPTION OF THE INVENTION

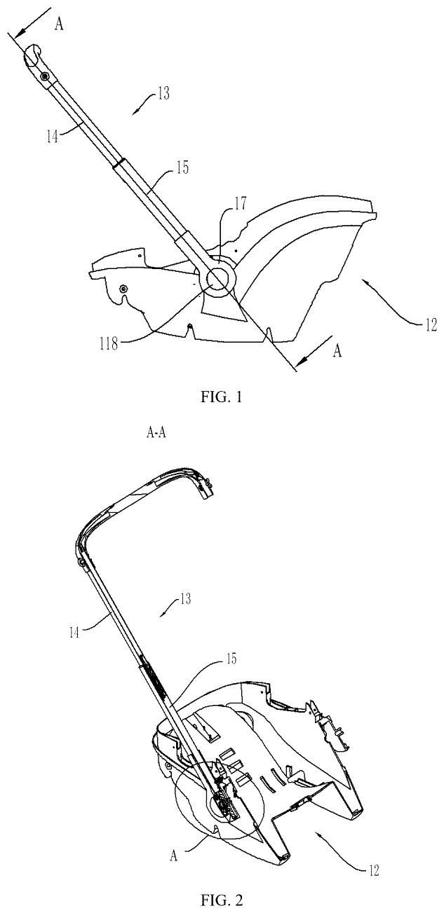

In the description of the present disclosure, references to directions such as “front”, “back”, “left”, “right”, “up”, “down”, etc. are intended to be defined with reference to directions observed when a child is seated, such as “front” in the left direction of the drawing, “back” in the right direction of the drawing, “up” in the upper direction of the drawing, “down” in the lower direction of the drawing, and “left” and “right” in directions perpendicular to the perspective of the drawing, as in FIG. 1. These definitions are intended merely to facilitate the description of the present disclosure and to simplify the description, and are not intended to indicate or imply that the device or element being referred to must have a particular orientation, be constructed and operated in a particular orientation and therefore should not be construed as limiting the present disclosure.

### First Embodiment

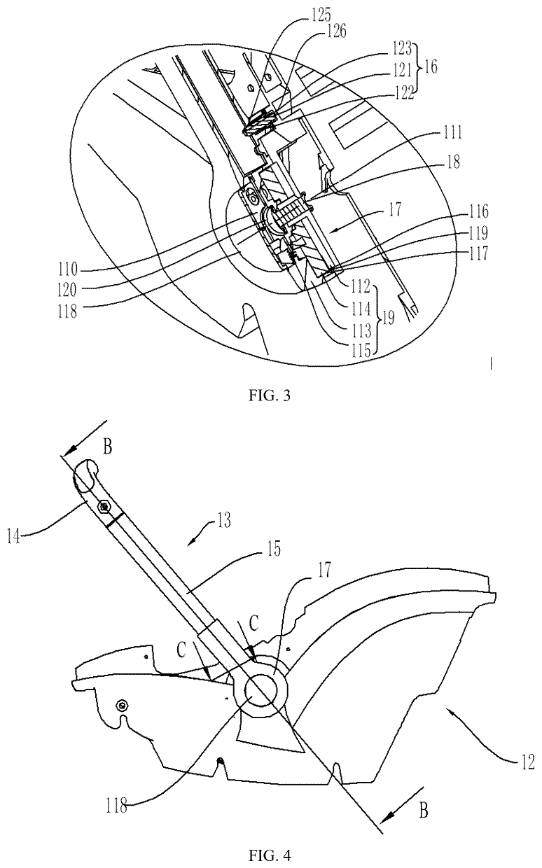

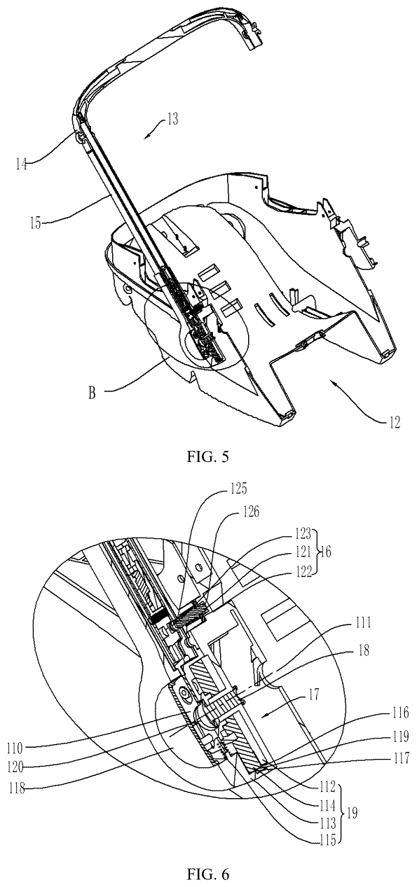

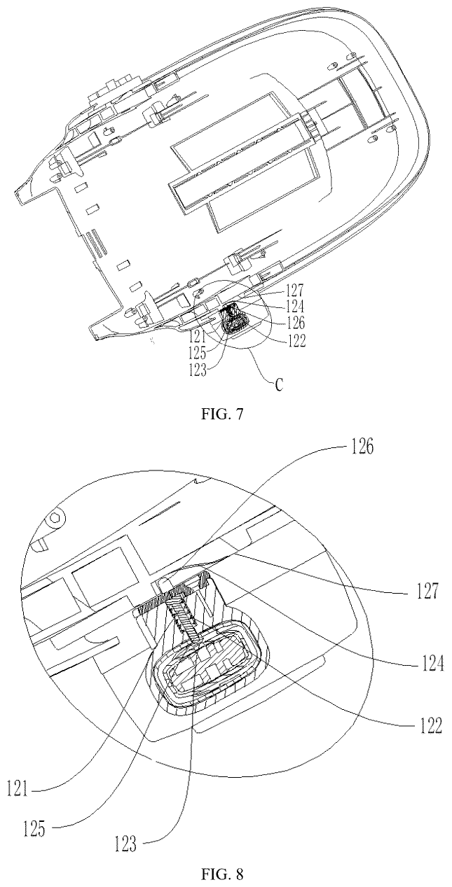

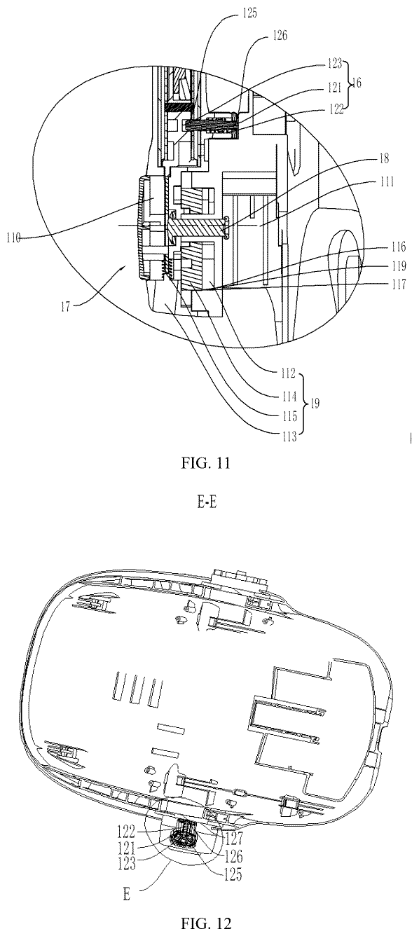

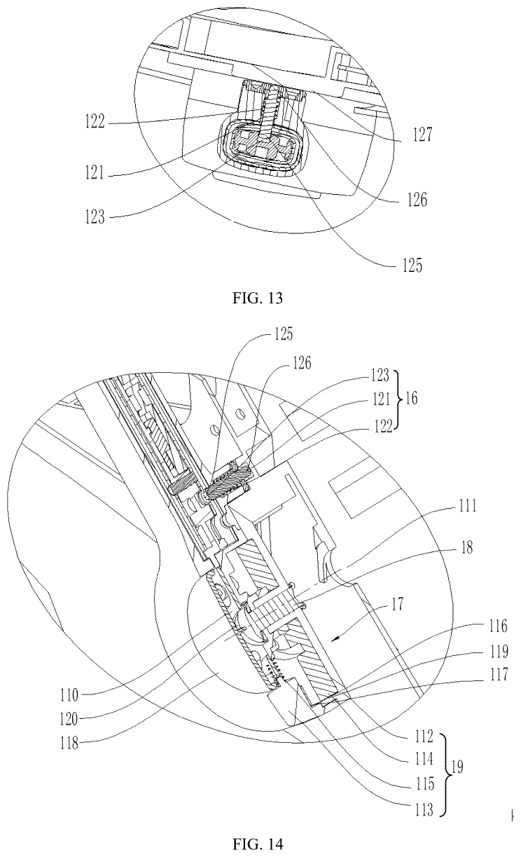

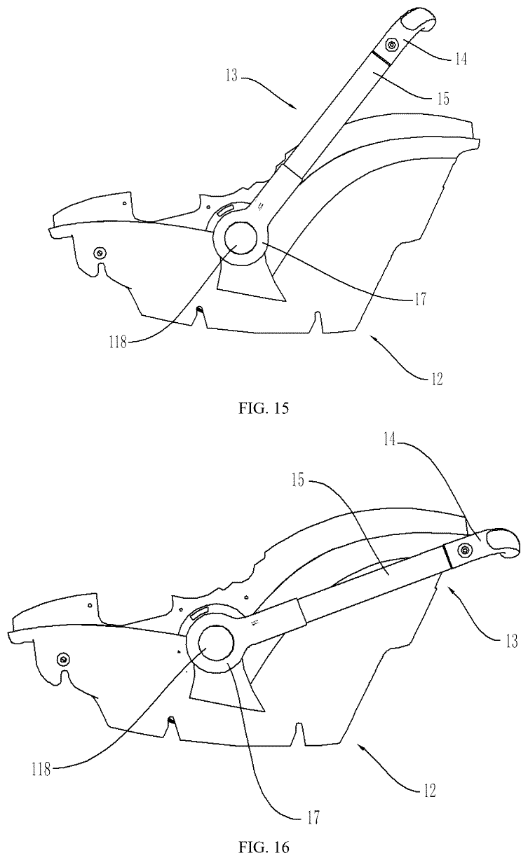

As shown in FIGS. 1 to 20, a child basket 11 of the present embodiment includes a seat body 12 and a telescopic handle 13 rotatably disposed on the seat body 12. The handle 13 includes an upper handle bar 14, a lower handle bar 15, and a latching mechanism 16. As shown in FIG. 3, FIG. 6, FIG. 11, and FIG. 14, the upper handle bar 14 is slidably disposed on the lower handle bar 15 in the direction in which the length of the lower handle bar 15 extends, and the handle 13 is rotatably connected to the seat body 12 via a joint 17.

In this embodiment, as shown in FIG. 2, the lower handle bar 15 has a cavity extending along its length, and the upper handle bar 14 is partially inserted into the cavity and slidably disposed along the length of the lumen.

The handle 13 and the seat body 12 are rotated via the joint 17 to have at least a push position and a basket position. The handle 13 is correspondingly switched to the corresponding position of the handle 13 after being rotated to different angles with respect to the seat body 12.

When the handle 13 is in the push position, the handle 13 extends obliquely. As shown in FIGS. 1, 17 and 18, the handle 13 may be in an extended state. As shown in FIG. 4, the handle 13 may also be in a retracted state and can be switched between an extended position or a retracted position. At this time, the child basket 11 is mounted on the frame 128 of the child stroller and is used as a seat pocket of the child stroller. The handle 13 may be used for pushing the child stroller (namely, as a push handle of the child stroller). The length of the handle 13 may be adjusted according to the requirements of the pusher.

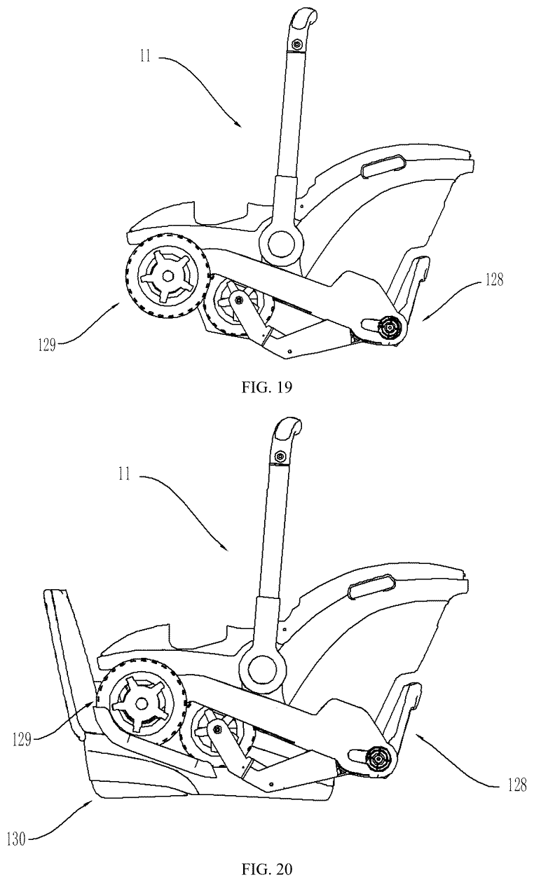

The push position includes a forward push position and a reverse push position. When the handle 13 is in the forward push position, the handle 13 extends obliquely upwards from the rear to the front, as shown in FIGS. 1, 4 and 17. When the handle 13 is in the reverse push position, the handle 13 extends obliquely from the front rearwards and upwards as shown in FIG. 18.

When the handle 13 is in the basket position, the handle 13 extends vertically or obliquely, and the handle 13 is in the retracted position and cannot be switched to the extended position. At this time, the handle 13 is mainly used to carry the child basket 11, which can be carried alone, as shown in FIG. 9.

The handle 13 also has an anti-tilt position located between the basket position and the push position. As shown in FIG. 15, when the handle 13 is in the anti-tilt position, the handle 13 is fixed relative to the seat body 12 to prevent tipping when carrying the child basket.

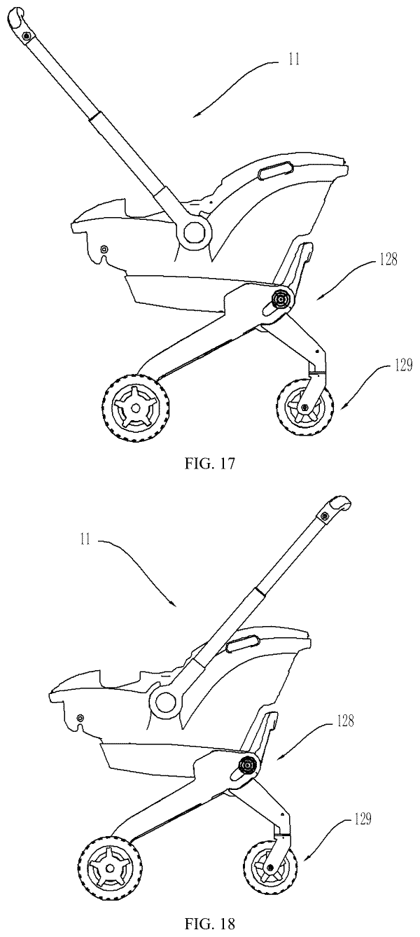

The handle 13 also has a safety seat position, as shown in FIG. 16. When the handle 13 is in the safety seat position, the handle 13 is in the retracted position and cannot be converted to the extended position.

The child basket 11 further includes a latching mechanism 16. The latching mechanism 16 includes a locking pin and a locking hole 123 cooperating with the locking pin 121. One of the locking pin 121 and the locking hole 123 is disposed on the upper handle bar 14, and the other one is disposed on the lower handle bar 15. The latching mechanism 16 has a locking configuration and an unlocking configuration. When the latching mechanism 16 is in the locking configuration, the handle 13 is locked at an extended position or a retracted position. When the latching mechanism 16 is in the unlocking configuration, the handle 13 is switchable between the extended position and the retracted position. The upper handle bar 14 slides with respect to the lower handle bar 15 such that the handle 13 extends/retracts. During extension of the upper handle bar 14, the length of the cavity through which the upper handle bar 14 extends out of the lower handle bar 15 increases and the length of the handle 13 increases. When the length of the upper handle bar 14 extending beyond the lower handle bar 15 reaches a maximum, the length of the handle 13 is the longest.

Specifically, as shown in FIG. 6, the latching mechanism 16 includes a locking pin 121 disposed on the lower handle bar 15, a spring 122 and a locking hole 123 provided on a lower portion of the upper handle bar 14. When the latching mechanism 16 is in a locking configuration, the locking pin 121 is inserted in the locking hole 123. When the latching mechanism is in an unlocking configuration, the locking pin 121 is disengaged from the locking hole 123. When the latching mechanism 16 is switched between the locking configuration and the unlocking configuration, the locking pin 121 slides with respect to the lower handle bar 15, and the sliding direction of the locking pin 121 is perpendicular to the sliding direction of the upper handle bar 14 with respect to the lower handle bar 15. The spring 122 is disposed between the locking pin 121 and the lower handle bar 15, and the spring 122 exerts a force on the locking pin 121 in a direction tending to move away from the locking hole 123.

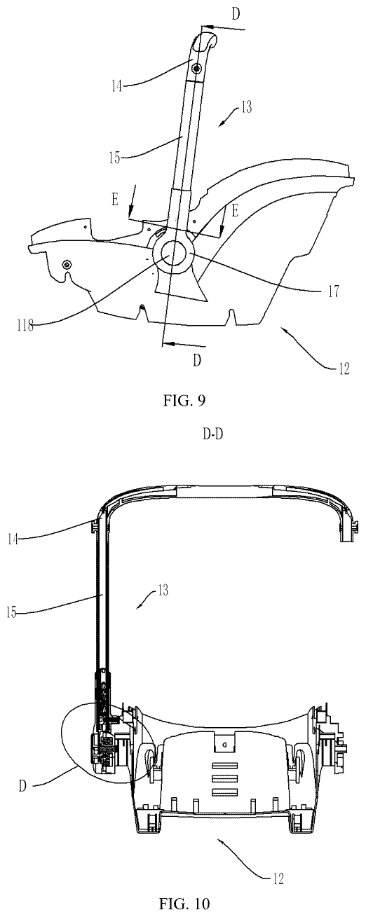

The child basket 11 further includes a locking coordination mechanism. The locking coordination mechanism is in contact with one end of the locking pin 121. During the rotation of the handle 13 about the handle shaft 18 with respect to the seat body 12, the locking coordination mechanism drives the latching mechanism 16 to switch from the unlocking configuration to the locking configuration, and the handle 13 is also switched from the push position to the basket position. The locking coordination mechanism includes a guiding inclined surface 124 disposed on a side surface of the seat body 12. As shown in FIG. 8, the guiding inclined surface 124 intersects with an axis 111 of the handle shaft 18 about which the handle 13 rotates with respect to the seat body 12. Specifically; the guiding inclined surface 124 gradually inclines from bottom to top in a direction away from the handle 13. During the switching of the handle 13 from the push position to the basket position, the guiding inclined surface 124 pushes the locking pin 121 to slide towards the locking hole 123.

With continued reference to FIG. 8, the locking pin 121 has a locking end portion 125 for insertion into the locking hole 123 and a driving end portion 126. During the switching of the handle 13 from the push position to the basket position, the driving end portion 126 abuts against and slides along the guiding inclined surface 124, which is progressively closer to the locking hole 123.

A locking plane 127 is disposed on the seat body 12 adjacent to the joint 17 side. The axis 111 of the handle shaft 18 is perpendicular to the locking plane 127, and the guiding inclined surface 124 intersects with the locking plane 127. When the handle 13 is switched between the basket position and the anti-tilt position or safety seat position, the driving end portion 126 presses against the locking plane 127 and is slidably connected, so that the latching mechanism 16 is continuously in the locking configuration.

The joint 17 includes the above-mentioned handle shaft 18, a locking mechanism 19 and a safety mechanism 110. The axis 111 of the handle shaft 18 extends along the left-right direction of the seat body 12, and both the locking mechanism 19 and the safety mechanism 110 have a locking configuration and an unlocking configuration. When the safety mechanism 110 is in the unlocking configuration, the locking mechanism 19 is allowed to enter the unlocking configuration from the locking configuration. At this time, the lower end portion of the lower handle bar 15 and the seat body 12 may rotate around the handle shaft 18. When the safety mechanism 110 is in the locking configuration, the locking mechanism 19 is unable to enter the unlocking configuration from the locking configuration, at which the relative position between the lower end portion of the lower handle bar 15 and the seat body 12 is locked.

The locking mechanism 19 includes a first engaging member 112 fixedly disposed on the seat body 12, a second engaging member 113 fixedly disposed on a lower end portion of the lower handle bar 15, a locking member 114 disposed between the first engaging member 112 and the second engaging member 113. An elastic member 115 abuts against the locking member 114 and used for driving the locking member 114 to slide in the direction of the axis 111 of the handle shaft 18 so that the locking member 114 has a tendency to lock at the relative positions with the first engaging member 112 and the second engaging member 113 at the same time.

When the locking mechanism 19 is in the locking configuration, the locking member 114 is locked with respect to the first engaging member 112 and the second engaging member 113 respectively. When the locking mechanism 19 is in the unlocking configuration, the locking member 114 is locked with respect to only one of the first engaging member 112 and the second engaging member 113, and is disengaged from the other one of the first engaging member 112 and the second engaging member 113. When the locking member 114 is moved, the locking mechanism 19 is switched between the locking configuration and the unlocking configuration.

The first engaging member 112 is provided with a first groove 116 radially recessed and extending along the axis 111 of the handle shaft 18. The second engaging member 113 is provided with a second recess 117 radially recessed and extending along the axis 111 of the handle shaft 18.

The locking member 114 is connected with a button 118 where the joint 17 is exposed. The locking member 114 is slidably disposed along the axis direction of the handle shaft 18. A radially extended protrusion is disposed on the locking member 114, and the protrusion 119 extends along the axis 111 of the handle shaft 18.

When the locking mechanism 19 is in the locking configuration, the protrusion 119 is inserted into the first groove 116 and the second groove 117 respectively, so that the locking member 114 is simultaneously engaged with the first engaging member 112 and the second engaging member 113. When the locking mechanism 19 is in the unlocking configuration, the protrusion 119 is disengaged from one of the first groove and the second groove and only inserted into the other one of the first groove and the second groove, so that the locking member is engaged with only one of the first engaging member and the second engaging member. When the button is pressed to drive the locking member to slide axially, the locking mechanism is switched between the locking configuration and the unlocking configuration.

The safety mechanism 110 is configured to lock the movement of the locking member 114 in the locking configuration, and allow the movement of the locking member 114 in the unlocking configuration. The safety mechanism 110 is a catch piece. When the safety mechanism 110 is in the locking configuration and the locking mechanism 19 is also in the locking configuration, the catch piece 120 blocks the movement path of the locking member 114. When the safety mechanism 110 is in an unlocking configuration, the catch piece 120 moves away from the movement path of the locking member 114. The movement path of the locking member 114 refers to a sliding path of the locking member 114 when the locking mechanism 19 is switched from the locking configuration to the unlocking configuration. The upper handle bar 14 pushes the catch piece 120 away from the movement path of the locking member 114 when the upper handle bar 14 slides downwards with respect to the lower handle bar 15 to the retracted position.

The process of switching the handle 13 of the child basket 11 between different positions in this embodiment is specifically described as follows.

When the handle 13 is switched from the push position to the basket position, the latching mechanism 16 is unlocked and the upper handle bar 14 may slide down with respect to the lower handle bar 15 to the retracted position. Pushing the catch piece 120 away from the movement path of the locking member 114 during downward sliding of the upper handle bar 14 enables the locking mechanism 19 to switch from the locking configuration to the unlocking configuration, the handle 13 being rotatable to different angles with respect to the seat body 12. During the rotation of the handle 13 about the handle shaft 18, the latching mechanism 16 is switched from the unlocking configuration to the locking configuration, namely, the upper handle bar 14 and the lower handle bar 15 cannot slide relative to each other, and the handle 13 is in the basket position.

When the handle 13 is switched from the basket position to the anti-tilt position or the safety seat position, the latching mechanism 16 is always in the locking configuration.

i.e., the upper handle bar 14 and the lower handle bar 15 cannot slide relative to each other. The user causes the locking member 114 to slide axially by pressing the button 118, thereby unlocking the locking mechanism 19 to effect rotation of the handle 13.

The child basket 11 in the present embodiment may be disposed on a frame 128 of the child stroller, and wheels 129 are disposed below the frame 128, as shown in FIGS. 17 to 19.

The child basket 11 in this embodiment may also be disposed on a frame 128 of the child car safety seat, below which are provided wheels 129 and a base 130. As shown in FIG. 20, the frame 128 has an unfolded configuration and a folded configuration. When in the folded configuration, the frame 128 is mounted on the base 130.

### Second Embodiment

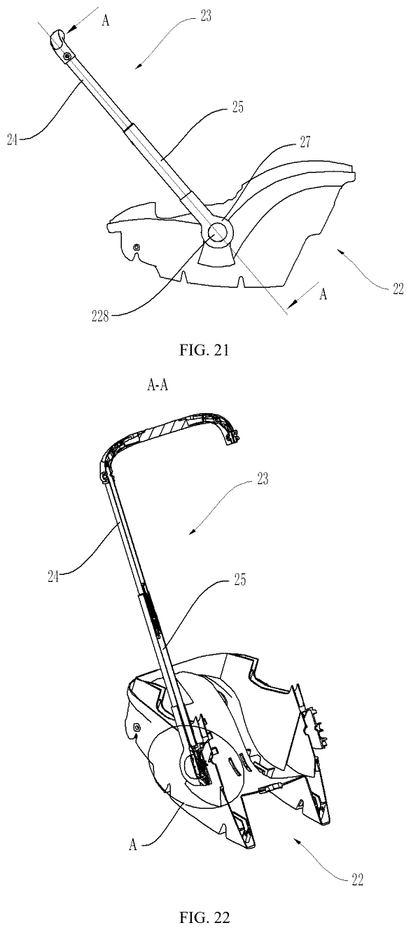

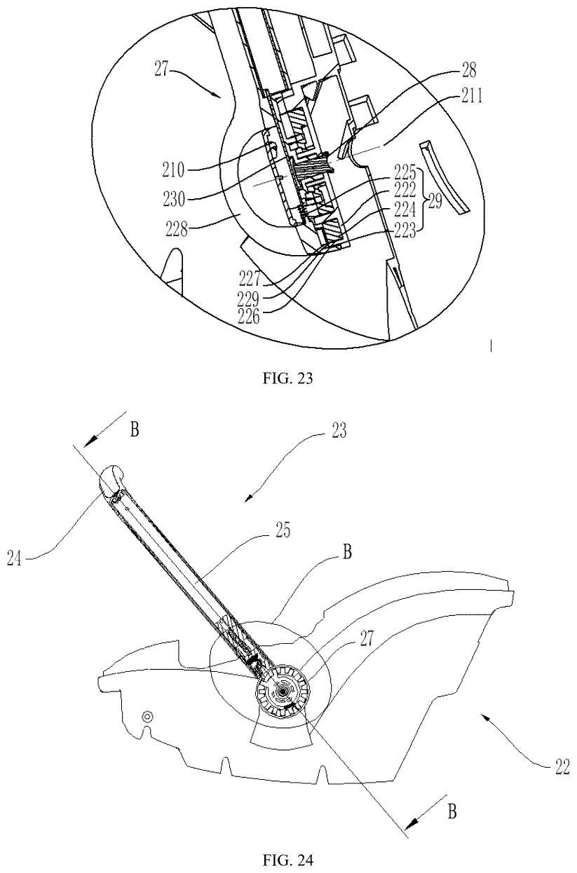

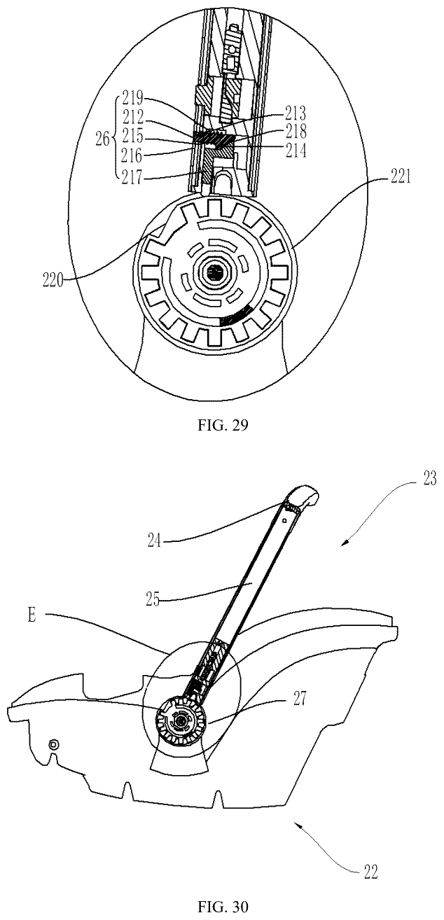

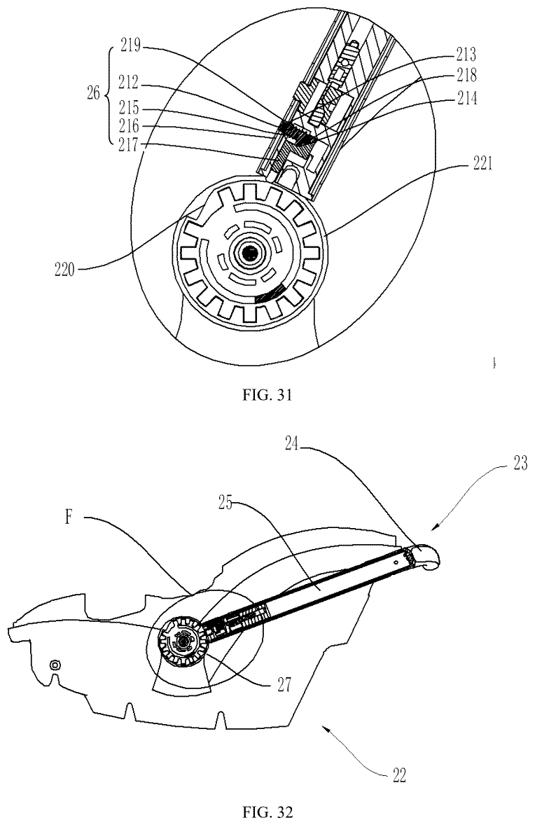

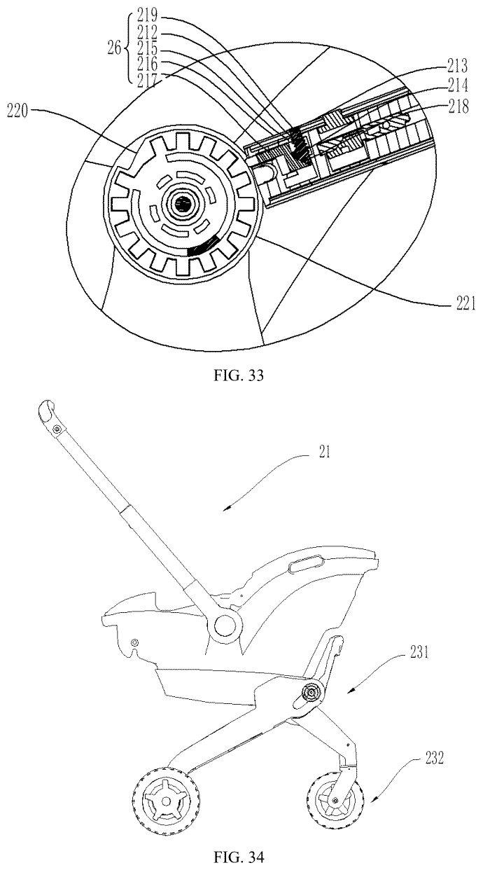

The second embodiment is basically the same as the first embodiment except for the specific structure and movement process of the latching mechanism 26 and the locking coordination mechanism. As shown in FIGS. 21 to 37, the child basket 21 of the present embodiment includes a seat body 22 and a telescopic handle 23 rotatably disposed on the seat body 22.

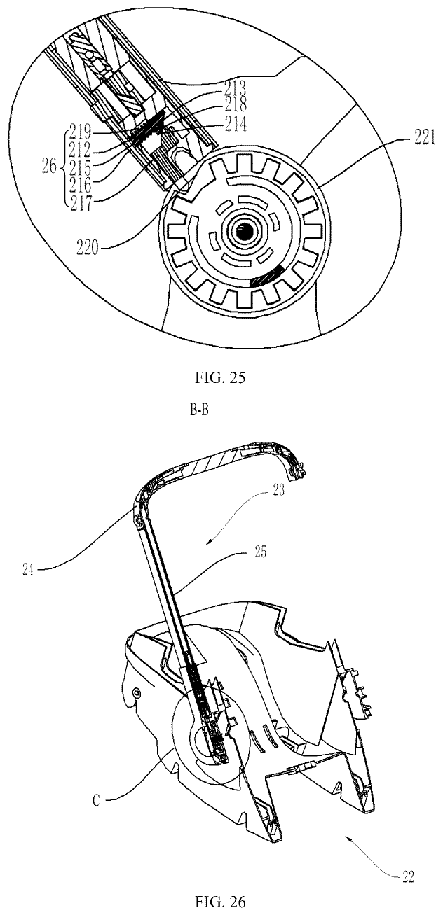

The handle 23 includes an upper handle bar 24, a lower handle bar 25, and a latching mechanism 26. As shown in FIGS. 25, 29, 31 and 33, the upper handle bar 24 is slidably disposed on the lower handle bar 25 in a direction in which the length of the lower handle bar 25 extends, and the handle 23 is rotatably connected to the seat body 22 via the joint 27.

As shown in FIGS. 21, 34 and 35, the handle 23 is in the push position and in the extended state. As shown in FIG. 24, the handle 23 may also be in a retracted state, in which the child basket 21 is mounted on the frame 231 of the child stroller for use as a seat pocket of the child stroller.

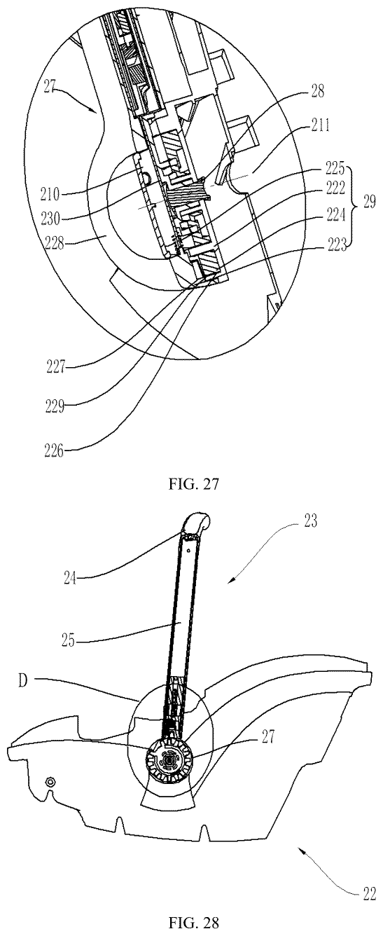

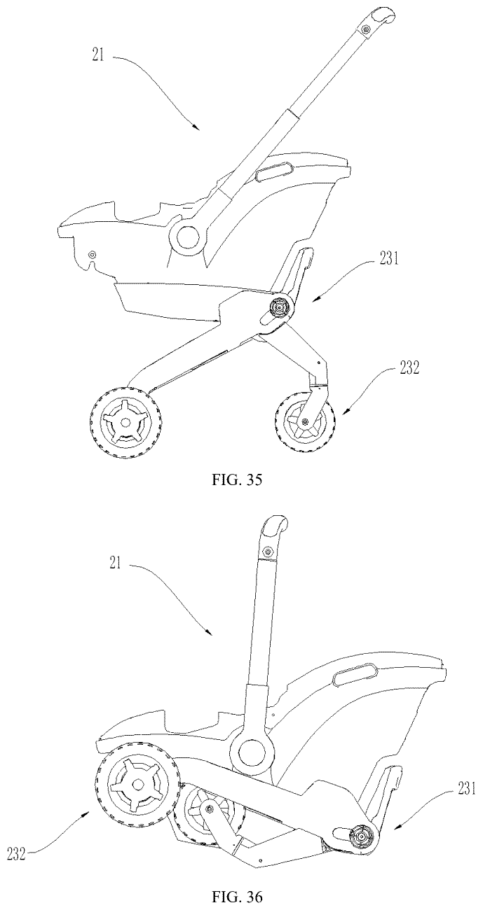

As shown in FIG. 21, FIG. 24 and FIG. 34, the handle 23 is in the forward push position. As shown in FIG. 35, the handle 23 is in the reverse push position. As shown in FIG. 28, the handle 23 is in the basket position, and the child basket 21 may be individually carried and used. As shown in FIG. 30, when the handle 23 is in the anti-tilt position, the handle 23 is fixed with respect to the seat body 22 to prevent tipping when carrying the child basket.

The handle 23 also has a safety seat position, as shown in FIG. 32. When the handle 23 is in the safety seat position, the handle 23 is in the retracted position and cannot be converted to the extended position.

As shown in conjunction with FIGS. 25, 29 and 31, the latching mechanism 26 includes a locking pin 212 that is disposed in the lower portion of the upper handle bar 24 and slidably connected to the upper handle bar 24. The sliding direction of the locking pin 212 is perpendicular to the sliding direction of the upper handle bar 24 with respect to the lower handle bar 25. The two ends of the locking pin 212 are referred to as a locking end portion 213 and a driving end portion 214, respectively. An upper handle bar locking hole 215 is disposed on a side wall of the upper handle bar 24 adjacent to the locking end portion 213. A lower handle bar locking hole is disposed on a lower side wall of the lower handle bar. A spring 219 is disposed between the upper handle bar 24 and the locking pin 212. The locking end portion 213 is inserted into the upper handle bar locking hole 215 and the lower handle bar locking hole 216 when the latching mechanism 26 is in the locking configuration. When the latching mechanism is in the unlocking configuration, the locking pin 212 is disengaged from the lower handle bar locking hole 216. When the latching mechanism 26 is switched between the locking configuration and the unlocking configuration, the locking pin 212 slides along the upper handle bar 24, and the spring 219 exerts a force on the locking pin 212 tending to switch into the unlocking configuration.

The child basket 21 further includes a locking coordination mechanism including a slider 217 disposed in a lower end portion of the upper handle bar 24 which is slidable along a sliding direction of the upper handle bar 24 with respect to the lower handle bar 25, an upper end portion of the slider 217 is in contact with the driving end portion 214 via a second guiding inclined surface 218 disposed on at least one of the upper end portion of the slider 217 and the driving end portion 214, so that the sliding direction of the slider 217 is perpendicular to the sliding direction of the locking pin 212, and the lower end portion of the slider 217 protrudes downwards from the lower end portion of the upper handle bar 24. Specifically, the second guiding inclined surfaces 218 are disposed on the upper end portion of the slider 217 and on the driving end portion 214, respectively. The second guiding inclined surfaces 218 on the upper end of the slider 217 are in face-to-face mating sliding contact with the first guiding inclined surfaces on the driving end portion 214.

The locking coordination mechanism further includes a first guiding inclined surface 220 disposed on a side surface of the seat body 22 with an included angle between the first guiding inclined surface 220 and a sliding direction of the slider 217. During the switching of the handle 23 from the push position to the basket position, the lower end portion of the slider 217 presses against the first guiding inclined surface 220 and is slidably connected, the first guiding inclined surface 220 pushes the slider 217 upwards, and the upper end portion of the slider 217 pushes the driving end portion 214 so that the locking pin 212 slides, thereby the locking end portion 213 moves towards the direction of insertion into the lower handle bar locking hole 216.

A circumferential surface 221 is disposed on the seat body 22 on a side adjacent to the joint 27. The circle of the circumferential surface 221 is centered on the axis 211 of the handle shaft. The first guiding inclined surface 220 is a tangent plane on the circumferential surface 221.

When the handle 23 is switched between the basket position and the anti-tilt position or the safety seat position, the lower end portion of the slider 217 presses against the circumferential surface 221 and is slidably connected, and the upper end portion of the slider 217 continuously presses against the locking pin 212, so that the latching mechanism 26 is in a locking configuration.

The joint 27 includes a handle shaft 28 of which the axis 211 extends in the left-right direction of the seat body 22, a locking mechanism 29, and a safety mechanism 210. The locking mechanism 29 includes a first engaging member 222, a second engaging member 223, a locking member 224, and an elastic member 225. The first engaging member 222 is fixedly disposed on the seat body 22. The second engaging member 223 is fixedly disposed at the lower end portion of the lower handle bar 25. The locking member 224 is disposed between the first engaging member 223 and the second engaging member 223. The elastic member 225 abuts against the locking member 224. The elastic member 225 is configured to drive the locking member 224 to slide along the axis 211 of the handle shaft, so that the locking member 224 has a tendency to lock with respect to both the first engaging member 222 and the second engaging member 223 at the same time:

The first engaging member 222 is provided with a first groove 226 radially recessed and extending in the direction of the axis 211 of the handle shaft. The second engaging member 223 is provided with a second groove 227 radially recessed and extending in the direction of the axis 211 of the handle shaft. The locking member 224 is connected with a button 228 where the joint is exposed. The locking member 224 is slidably disposed along the axis direction of the handle shaft. A radially extended protrusion 229 is disposed on the locking member 224, and the protrusion 229 extends along the axis 211 of the handle shaft.

The safety mechanism 210 is configured to lock movement of the locking member 224 in the locking configuration and allow movement of the locking member 224 in the unlocking configuration. The safety mechanism 210 is a catch piece 230. When the safety mechanism 210 is in the locking configuration and the locking mechanism 29 is also in the locking configuration, the catch piece 230 blocks the movement path of the locking member 224.

The process of switching the handle 23 of the child basket 21 between different positions in this embodiment is specifically described as follows.

When the handle 23 is switched from the push position to the basket position, the latching mechanism 26 is unlocked and the upper handle bar 24 may slide down with respect to the lower handle bar 25 to the retracted position. Pushing the catch piece 230 away from the movement path of the locking member 224 during downward sliding of the upper handle bar 24 enables the locking mechanism 29 to switch from the locking configuration to the unlocking configuration, the handle 23 being rotatable to different angles with respect to the seat body 22. During the rotation of the handle 23 about the handle shaft 28, the latching mechanism 26 is switched from the unlocking configuration to the locking configuration, namely, the upper handle bar 24 and the lower handle bar 25 cannot slide relative to each other, and the handle 23 is in the basket position.

When the handle 23 is switched from the basket position to the anti-tilt position or the safety seat position, the latching mechanism 26 is always in the locking configuration, i.e., the upper handle bar 24 and the lower handle bar 25 cannot slide relative to each other. The user causes the locking member 224 to slide axially by pressing the button 228, thereby unlocking the locking mechanism 29 to effect rotation of the handle 23.

The child basket 21 in the present embodiment may be disposed on a frame 231 of the child stroller, and wheels 232 are disposed below the frame 231, as shown in FIGS. 34 to 36.

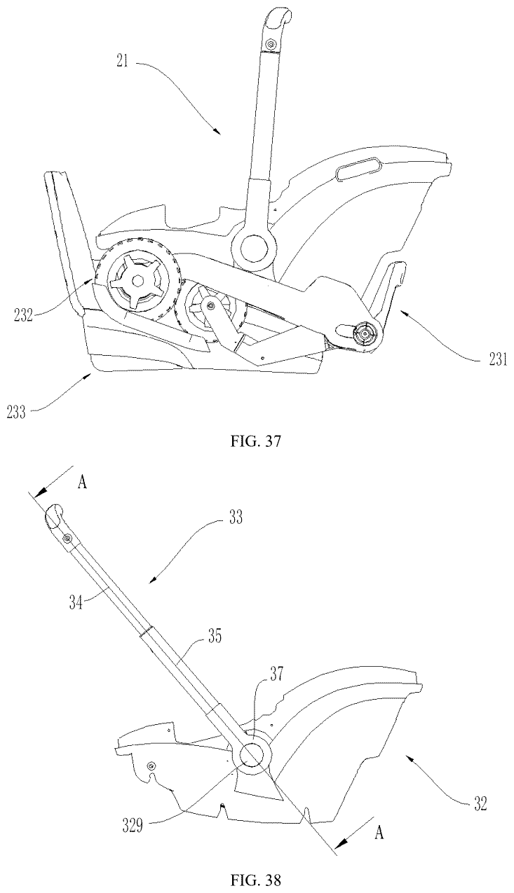

The child basket 21 in the present embodiment may also be disposed on a frame 231 of the child car safety seat, below which wheels 232 and a base 233 are provided. As shown in FIG. 37, the frame 231 has an unfolded configuration and a folded configuration. When in the folded configuration, the frame 231 is mounted on the base 233.

### Third Embodiment

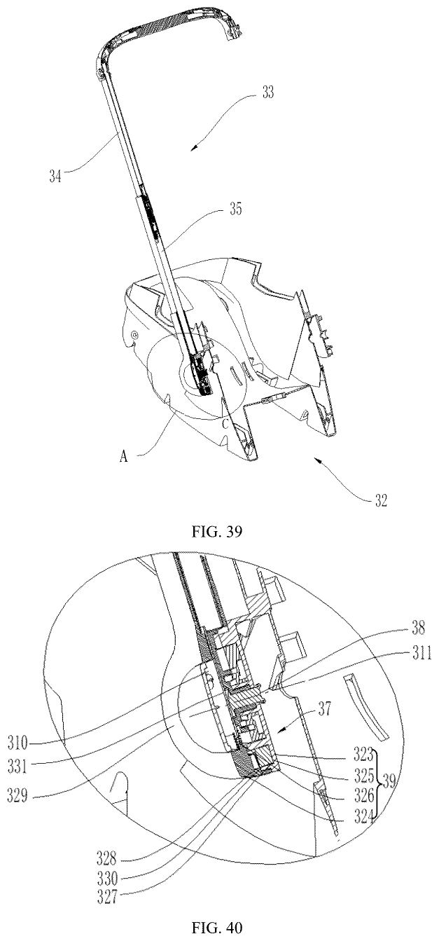

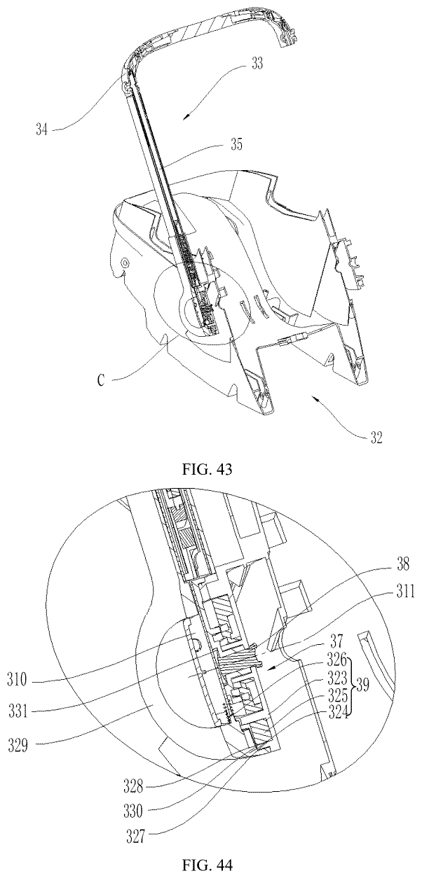

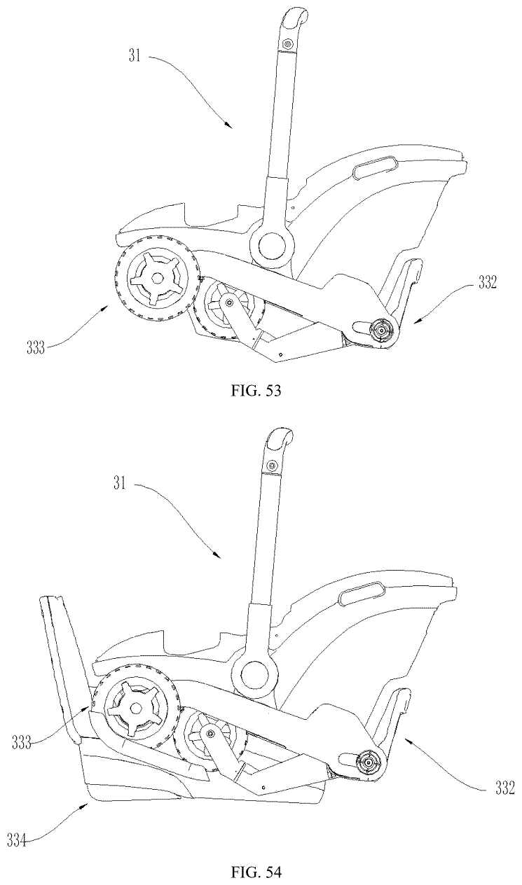

The third embodiment is basically the same as the second embodiment except for the specific structure and movement process of the latching mechanism 36 and the locking coordination mechanism. As shown in FIGS. 38 to 54, the child basket 31 of the present embodiment includes a seat body 32 and a telescopic handle 33 rotatably disposed on the seat body 32.

The handle 33 includes an upper handle bar 34, a lower handle bar 35, and a latching mechanism 36. As shown in FIGS. 42, 46, 48 and 50, the upper handle bar 34 is slidably disposed on the lower handle bar 35 in a direction in which the length of the lower handle bar 35 extends, and the handle 33 is rotatably connected to the seat body 32 via the joint 37.

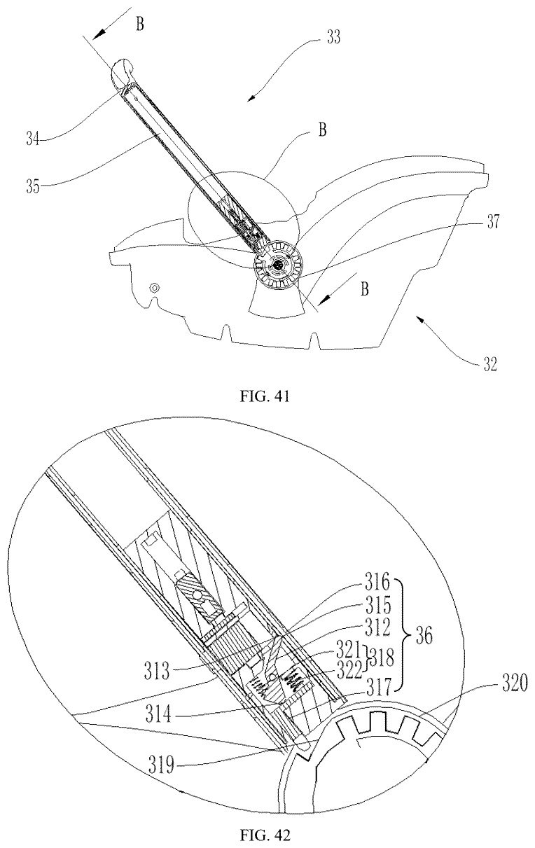

As shown in FIGS. 38, 51 and 52, the handle 33 is in the push position and in the extended state. As shown in FIG. 41, the handle 33 may also be in a retracted state, in which the child basket 31 is mounted on the frame 332 of the child stroller for use as a seat pocket of the child stroller.

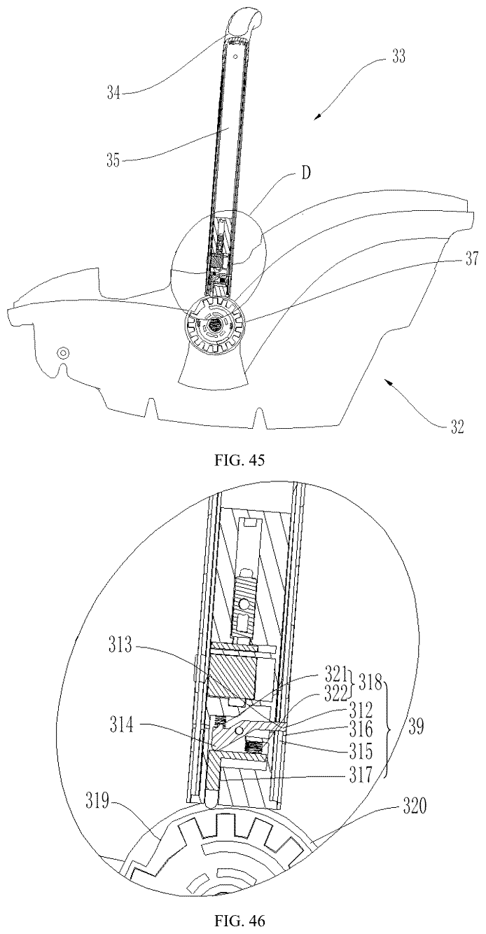

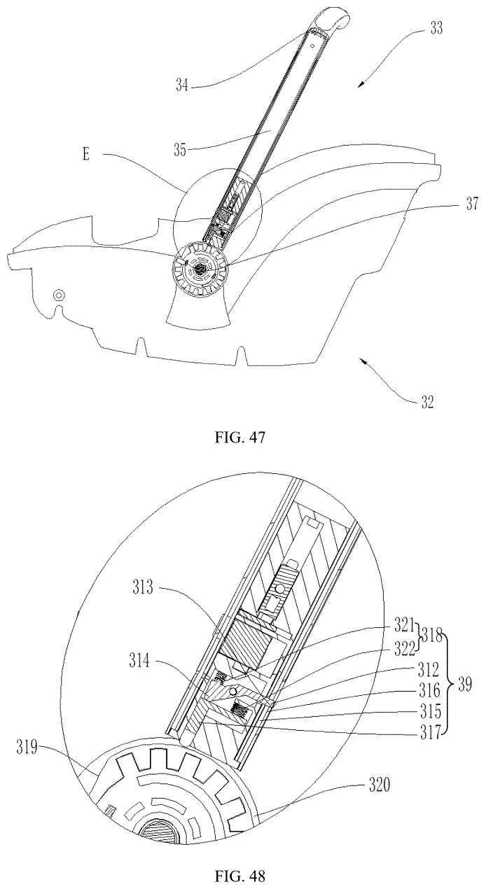

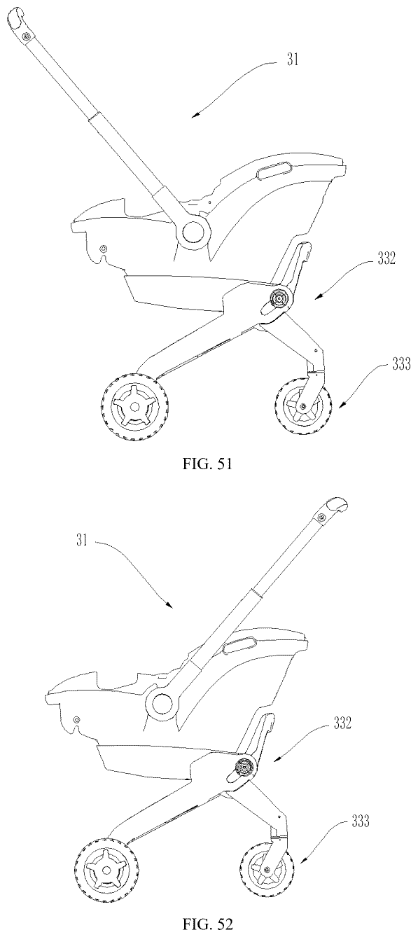

As shown in FIG. 38, FIG. 41 and FIG. 51, the handle 33 is in the forward push position. As shown in FIG. 52, the handle 33 is in the reverse push position. As shown in FIG. 45, the handle 33 is in the basket position, and the child basket 31 may be individually carried and used. As shown in FIG. 47, when the handle 33 is in the anti-tilt position, the handle 33 is fixed with respect to the seat body 32 to prevent tipping when carrying the child basket.

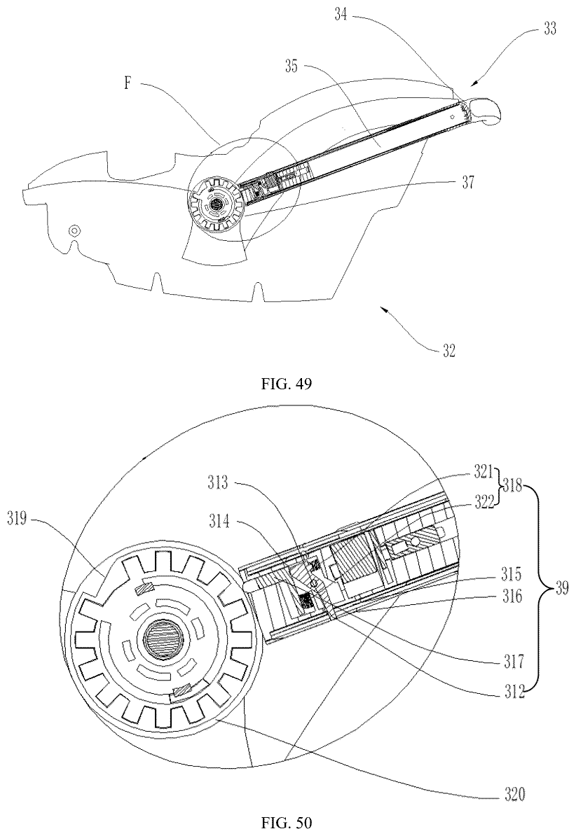

The handle 33 also has a safety seat position, as shown in FIG. 49. When the handle 33 is in the safety seat position, the handle 33 is in the retracted position and cannot be converted to the extended position.

As shown in conjunction with FIGS. 42, 46 and 48, the latching mechanism 36 includes a locking pin 312 pivotally connected within the lower portion of the upper handle bar 34 by a locking pin shaft, the locking pin ends on either side of the locking pin shaft being referred to as a locking end portion 313 and a driving end portion 314, respectively. An upper handle bar locking hole 315 is disposed on a side wall of the upper handle bar 34 adjacent to the locking end portion 313. A lower handle bar locking hole 316 is disposed on a lower side wall of the lower handle bar 35. A spring 318 is disposed between the upper handle bar 34 and the locking pin 312. The locking end portion 313 is inserted into the upper handle bar locking hole 315 and the lower handle bar locking hole 316 when the latching mechanism 36 is in the locking configuration. When the latching mechanism 36 is in the unlocking configuration, the locking pin 312 is disengaged from the lower handle bar locking hole 316. When the latching mechanism 36 is switched between the locking configuration and the unlocking configuration, the locking pin 312 rotates about the locking pin shaft, and the spring 318 exerts a force on the locking pin 312 tending to switch into the unlocking configuration.

The child basket 31 further includes a locking coordination mechanism including a slider 317 disposed on a lower end portion of the upper handle bar 34 which is slidable along a length direction of the upper handle bar 34. An upper portion of the slider 317 abuts against the driving end portion, and a lower end portion of the slider protrudes downwards from the lower end portion of the upper handle bar. In other embodiments, a spring 318 is disposed between the upper handle bar 34 and the slider 317. Specifically, the spring 318 includes a first spring 321 disposed between the upper handle bar 34 and the locking pin 312 and a second spring 322 disposed between the upper handle bar 34 and the slider 317.

The locking coordination mechanism further includes a guiding inclined surface 319 disposed on a side surface of the seat body 32 with an included angle between the guiding inclined surface 319 and the sliding direction of the slider 317. During the switching of the handle bar 33 from the push position to the basket position, the lower end portion of the slider 317 presses against and is slidably connected to the guiding inclined surface 319. The guiding inclined surface 319 pushes the slider 317 upwards, and the upper portion of the slider 317 pushes the driving end 314 upwards so that the locking pin 312 rotates about the locking pin shaft, thereby moving the locking end portion 313 towards the direction of insertion into the lower handle bar locking hole 316.

A circumferential surface 320 is disposed on a side of the seat body 32 adjacent to the rotation joint 37. The center of the circumferential surface 320 is an axis 311 of the handle shaft. The guiding inclined surface 319 is a tangent plane on the circumferential surface 320).

When the handle bar 33 is switched between the basket position and the anti-tilt position or the safety seat position, the lower end portion of the slider 317 presses against the circumferential surface 320 and is slidably connected therewith. The upper end portion of the slider 317 continuously presses against the driving end portion 314, so that the latching mechanism 36 is in a locking configuration.

The joint 37 includes a handle shaft 38 of which the axis 311 extends in the left-right direction of the seat body 32, a locking mechanism 39, and a safety mechanism 310. The locking mechanism 39 includes a first engaging member 323, a second engaging member 324, a locking member 325, and an elastic member 326. The first engaging member 323 is fixedly disposed on the seat body 32. The second engaging member 324 is fixedly disposed at the lower end portion of the lower handle bar 35. The locking member 325 disposed between the first engaging member 323 and the second engaging member 324. The elastic member 326 abuts against the locking member 325. The elastic member 326 is configured to drive the locking member 325 to slide along the axis 311 of the handle shaft, so that the locking member 325 has a tendency to lock with respect to both the first engaging member 323 and the second engaging member 324 at the same time:

The first engaging member 323 is provided with a first groove 327 radially recessed and extended along the axis of the handle shaft 311. The second engaging member 324 is provided with a second groove 328 radially recessed and extended along the axis 311 of the handle shaft. The locking member 325 is connected with a button 329 where the joint is exposed. The locking member 325 is slidably disposed along the axis direction of the handle shaft. A radially extended protrusion 330 is disposed on the locking member 325, and the protrusion 330 extends along the axis 311 of the handle shaft. The safety mechanism 310 is used for locking the movement of the locking member 325 in the locking configuration and allowing the movement of the locking member 325 in the unlocking configuration. The safety mechanism 310 is a catch piece 331. When the safety mechanism 310 is in the locking configuration and the locking mechanism 39 is also in the locking configuration, the catch piece 331 blocks the movement path of the locking member 325.

The process of switching the handle 33 of the child basket 31 between different positions in this embodiment is specifically described as follows.

When the handle 33 is switched from the push position to the basket position, the latching mechanism 36 is unlocked and the upper handle bar 34 may slide down with respect to the lower handle bar 35 to the retracted position. Pushing the catch piece 331 away from the movement path of the locking member 325 during downward sliding of the upper handle bar 34 enables the locking mechanism 39 to switch from the locking configuration to the unlocking configuration, the handle 33 being rotatable to different angles with respect to the seat body 32. During the rotation of the handle 33 about the handle shaft 38, the latching mechanism 36 is switched from the unlocking configuration to the locking configuration, namely, the upper handle bar 34 and the lower handle bar 35 cannot slide relative to each other, and the handle 33 is in the basket position.

When the handle 33 is switched from the basket position to the anti-tilt position or the safety seat position, the latching mechanism 36 is always in the locking configuration, i.e., the upper handle bar 34 and the lower handle bar 35 cannot slide relative to each other. The user causes the locking member 325 to slide axially by pressing the button 329, thereby unlocking the locking mechanism 39 to effect rotation of the handle 33.

The child basket 31 in the present embodiment may be disposed on a frame 332 of the child stroller, and wheels 333 are disposed below the frame 332, as shown in FIGS. 51 to 53.

The child basket 31 in this embodiment may also be disposed on a frame 332 of the child car safety seat, below which are provided wheels 333 and a base 334. As shown in FIG. 54, the frame 332 has an unfolded configuration and a folded configuration. When in the folded configuration, the frame 332 is mounted on the base 334.

### Fourth Embodiment

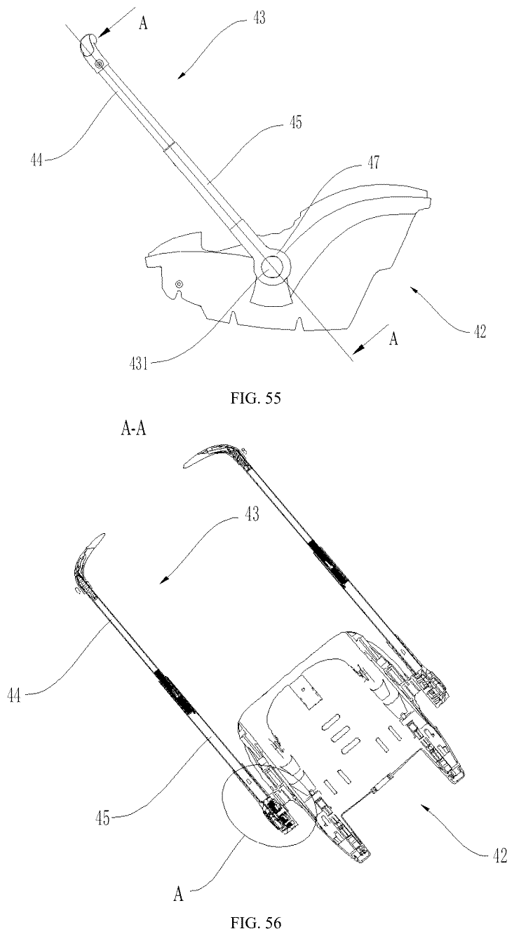

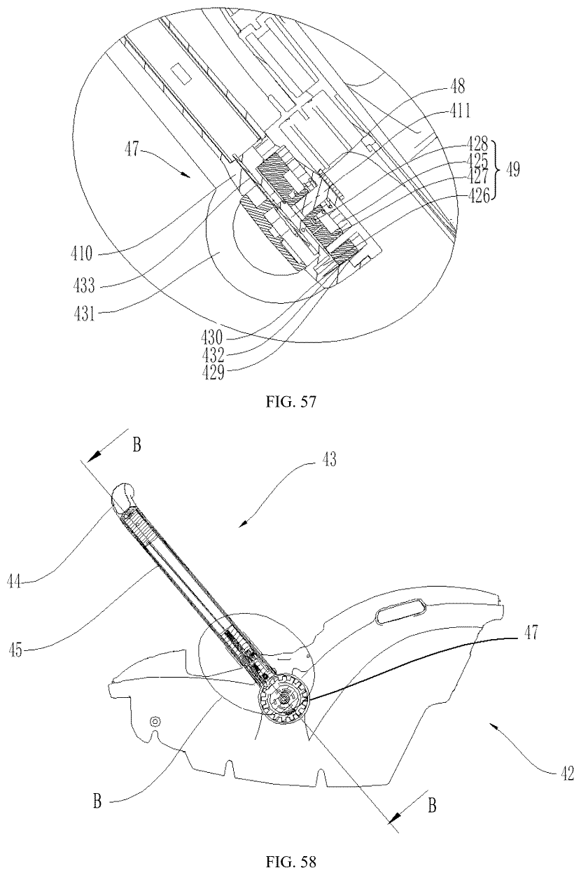

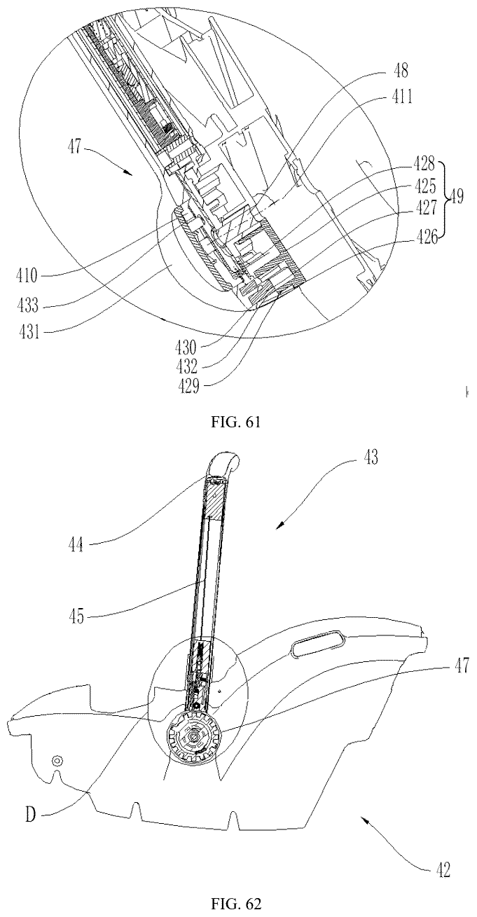

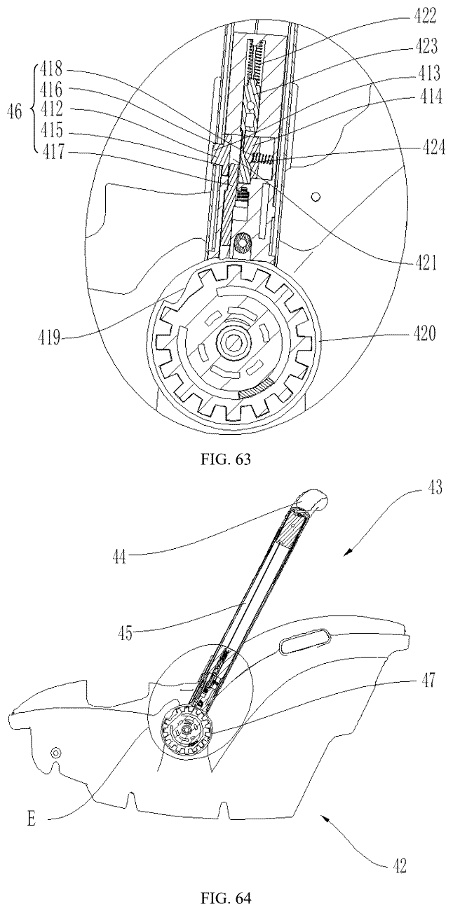

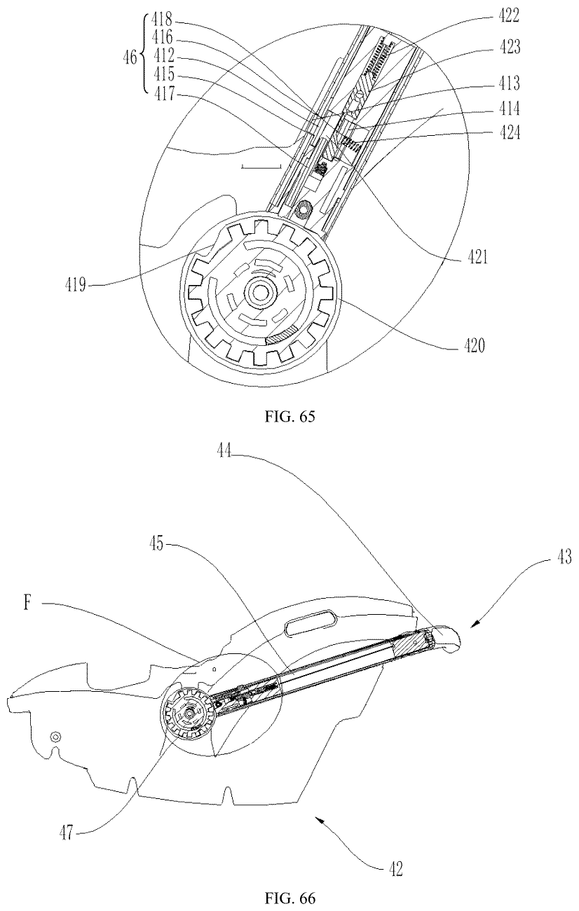

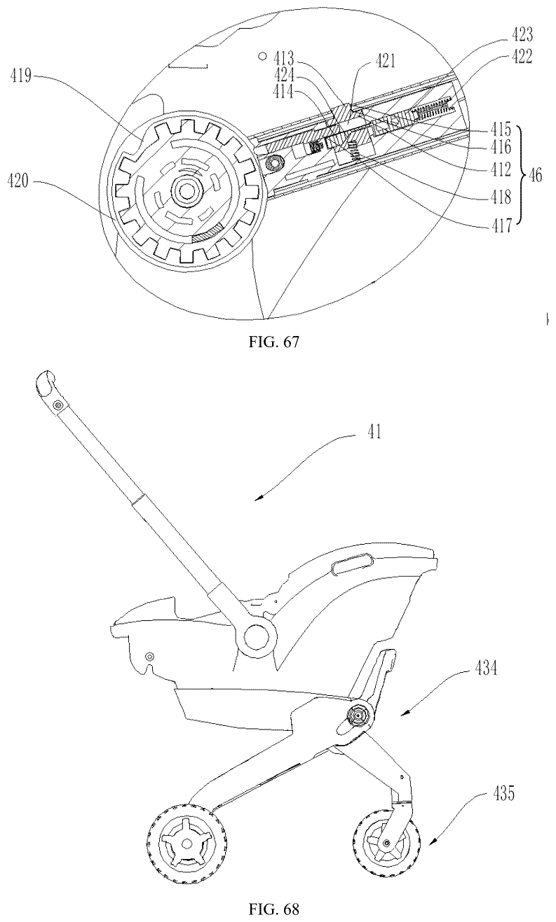

This fourth embodiment is basically the same as the first embodiment except for the specific structure and movement process of the latching mechanism 46 and the locking coordination mechanism. As shown in FIGS. 55 to 71, the child basket 41 in the present embodiment includes a seat body 42 and a telescopic handle 43 rotatably disposed on the seat body 42.

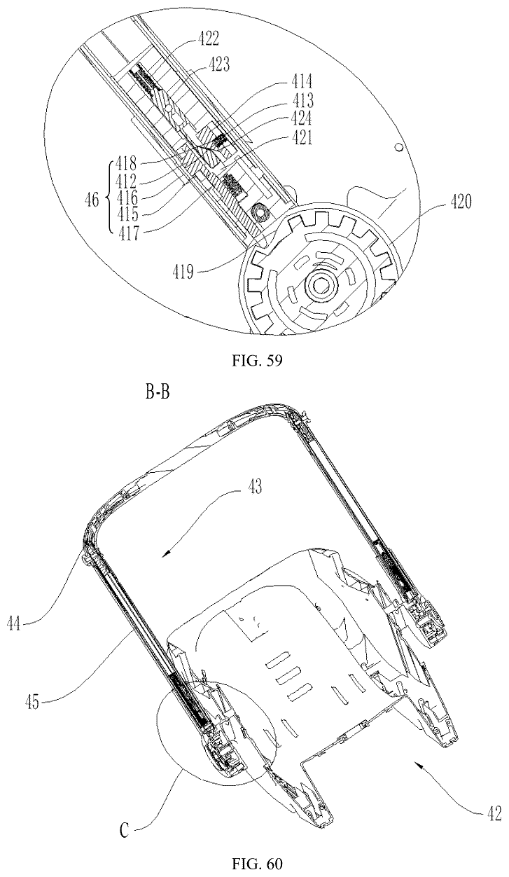

The handle 43 includes an upper handle bar 44, a lower handle bar 45, and a latching mechanism 46. As shown in FIGS. 59, 63, 65 and 67, the upper handle bar 44 is slidably disposed on the lower handle bar 45 in a direction in which the length of the lower handle bar 45 extends, and the handle 43 is rotatably connected to the seat body 42 via the joint 47.

As shown in FIGS. 55, 68 and 69, the handle 43 is in the push position and in the extended state. As shown in FIG. 58, the handle 43 may also be in a retracted state, in which the child basket 41 is mounted on the frame 434 of the child stroller for use as a seat pocket of the child stroller.

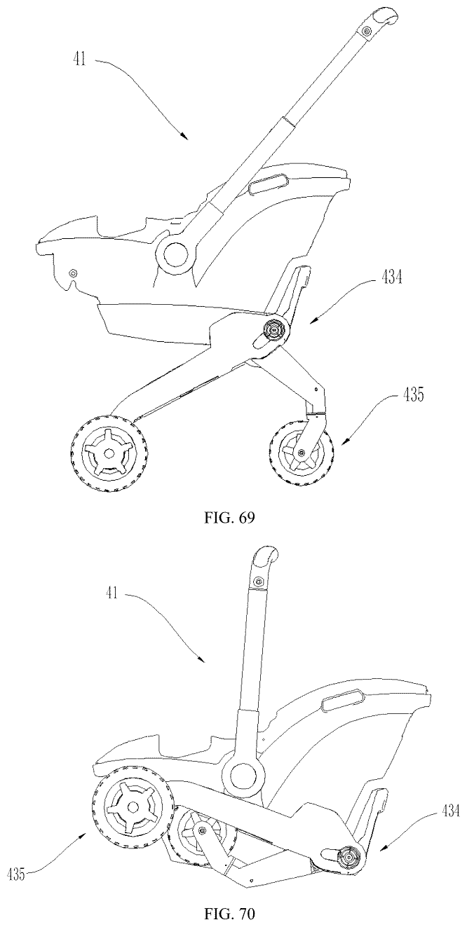

As shown in FIG. 55, FIG. 58 and FIG. 68, the handle 43 is in the forward push position. As shown in FIG. 69, the handle 43 is in the reverse push position. As shown in FIG. 62, the handle 43 is in the basket position, and the child basket 41 may be individually carried and used. As shown in FIG. 64, when the handle 43 is in the anti-tilt position, the handle 43 is fixed with respect to the seat body 42 to prevent tipping when carrying the child basket.

The handle 43 also has a safety seat position, as shown in FIG. 66. When the handle 43 is in the safety seat position, the handle 43 is in the retracted position and cannot be converted to the extended position.

As shown in conjunction with FIGS. 59, 63 and 65, the latching mechanism 46 includes a locking pin 412 disposed in a lower portion of the upper handle bar 44 and slidably connected to the upper handle bar 44. The sliding direction of the locking pin 412 is perpendicular to the sliding direction of the upper handle bar 44 with respect to the lower handle bar 45. The locking pin 412 has a locking portion 413 and a movable portion 414. An upper handle bar locking hole is disposed on a side wall of the upper handle bar 44 adjacent to the locking portion 413. A lower handle bar locking hole 416 is disposed at a lower side wall of the lower handle bar 45. A spring 418 is disposed between the upper handle bar 44 and the locking pin 412.

When the latching mechanism 46 is in the locking configuration, the locking portion 413 is inserted into the upper handle bar locking hole 415 and the lower handle bar locking hole 416. When the latching mechanism 46 is in the unlocking configuration, the locking portion 413 is disengaged from the lower handle bar locking hole 416. As the latching mechanism 46 is switched between the locking configuration and the unlocking configuration, the locking pin 412 slides along the upper handle bar 44 and the spring 418 exerts a force on the locking pin 412 tending to switch into the locking configuration.

The child basket 41 further includes a locking coordination mechanism including a slider 417 slidably disposed in a lower end portion of the upper handle bar 44 in a sliding direction of the upper handle bar 44 with respect to the lower handle bar 45. The lower end portion of the slider 417 protrudes downwards from the lower end portion of the upper handle bar 44. When the latching mechanism is in the locking configuration, the upper portion of the slider blocks the movement path of the locking pin. When the latching mechanism is in the unlocking configuration, the upper portion of the slider is away from the movement path of the locking pin. The movement path of the locking member refers to a sliding path of the locking pin when the latching mechanism is switched from the locking configuration to the unlocking configuration.

The locking coordination mechanism further includes a first guiding inclined surface 419 disposed on a side surface of the seat body 42, as shown in FIGS. 59, 63, 65 and 67, with an included angle between the first guiding inclined surface 419 and a sliding direction of the slider 417. During the switching of the handle bar 43 from the push position to the basket position, the lower end portion of the slider 417 presses against and is slidably connected to the first guiding inclined surface 419, which pushes the slider 417 to slide upwards so that the upper portion of the slider 417 blocks the movement path of the locking pin 412, thereby keeping the locking portion 413 inserted in the lower handle bar locking hole 416.

A circumferential surface 420 is disposed on a side of the seat body 42 adjacent to the rotation joint 47. The circle of the circumferential surface 420 is centered on the axis 411 of the handle shaft. The first guiding inclined surface 419 is a tangent plane on the circumferential surface 420.

When the handle bar 43 is switched between the basket position and the anti-tilt or safety seat position, the lower end portion of the slider 417 abuts against the circumferential surface 420 and is slidably connected therewith so that the upper portion of the slider 417 continuously blocks the movement path of the locking pin 412. An insertion hole 421 is formed in the locking pin. An upper portion of the slider 417 is inserted into the insertion hole 421 when the latching mechanism 46 is in the locking configuration. When the latching mechanism 46 is in the unlocking configuration, the upper portion of the slider 417 is disengaged from the insertion hole 421. As shown in FIG. 59, a traction device 422 is disposed in the upper handle bar 44. An unlocking guide block 423 is connected to the traction device 422. The unlocking guide block 423 is at least partially inserted into the insertion hole 421. One side of the unlocking guide block 423 is in contact with an inner wall of one side of the insertion hole 421 via the third guiding inclined surface 424. An included angle is provided between the third guiding inclined surface 424 and the sliding direction of the locking pin 412. The third guiding inclined surface 424 is disposed on the movable portion 414. In other embodiments, the third guiding inclined surface 424 may also be disposed on the unlocking guide block 423. When the latching mechanism 46 is in the locking configuration, the upper portion of the slider 417 is located between the other side inner wall of the insertion hole 421 and the other side of the unlocking guide block 423. When the upper portion of the slider 417 is disengaged from the insertion hole 421, the traction device 422 pulls the unlocking guide block 423, and the third guiding inclined surface 424 pushes the movable portion to slide in a direction away from the lower handle bar locking hole 416, so that the latching mechanism 46 is in the unlocking configuration.

The joint 47 includes a handle shaft 48 of which the axis 411 extends in the left-right direction of the seat body 42, a locking mechanism 49, and a safety mechanism 410. The locking mechanism 49 includes a first engaging member 425, a second engaging member 426, a locking member 427, and an elastic member 428. The first engaging member 425 is fixedly disposed on the seat body 42. The second engaging member 426 is fixedly disposed at the lower end portion of the lower handle bar 45. The locking member 427 disposed between the first engaging member 425 and the second engaging member 426. The elastic member 428 abuts against the locking member 427. The elastic member 428 is configured to drive the locking member 427 to slide along the axis 411 of the handle shaft, so that the locking member 427 has a tendency to lock with respect to both the first engaging member 425 and the second engaging member 426 at the same time:

The first engaging member 425 is provided with a first groove 429 radially recessed and extended along the axis 411 of the handle shaft. The second engaging member 426 is provided with a second groove 430 radially recessed and extended along the axis 411 of the handle shaft. The locking member 427 is connected with a button 431 where the joint is exposed. The locking member 427 is slidably disposed along the axis direction of the handle shaft. A radially extended protrusion 432 is disposed on the locking member 427, and the protrusion 432 extends along the axis 411 of the handle shaft. The safety mechanism 410 is used for locking the movement of the locking member 427 in the locking configuration and allowing the movement of the locking member 427 in the unlocking configuration. The safety mechanism 410 is a catch piece 433. When the safety mechanism 410 is in the locking configuration and the locking mechanism 49 is also in the locking configuration, the catch piece 433 blocks the movement path of the locking member 427.

The process of switching the handle 43 of the child basket 41 between different positions in this embodiment is specifically described as follows.

When the handle 43 is switched from the push position to the basket position, the latching mechanism 46 is unlocked and the upper handle bar 44 may slide down with respect to the lower handle bar 45 to the retracted position. Pushing the catch piece 433 away from the movement path of the locking member 427 during downward sliding of the upper handle bar 44 enables the locking mechanism 49 to switch from the locking configuration to the unlocking configuration, the handle 43 being rotatable to different angles with respect to the seat body 42. During the rotation of the handle 43 about the handle shaft 48, the latching mechanism 46 is switched from the unlocking configuration to the locking configuration, namely, the upper handle bar 44 and the lower handle bar 45 cannot slide relative to each other, and the handle 43 is in the basket position.

When the handle 43 is switched from the basket position to the anti-tilt position or the safety seat position, the latching mechanism 46 is always in the locking configuration, i.e., the upper handle bar 44 and the lower handle bar 45 cannot slide relative to each other. The user causes the locking member 427 to slide axially by pressing the button 431, thereby unlocking the locking mechanism 49 to effect rotation of the handle 43. The child basket 41 in the present embodiment may be disposed on a frame 434 of the child stroller, and wheels 435 are disposed below the frame 434, as shown in FIGS. 68 to 70.

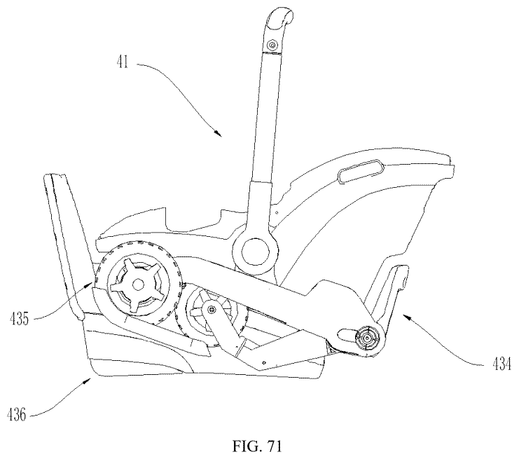

The child basket 41 in this embodiment may also be disposed on a frame 434 of the child car safety seat, below which are provided wheels 435 and a base 436. As shown in FIG. 71, the frame 434 has an unfolded configuration and a folded configuration. When in the folded configuration, the frame 434 is mounted on the base 436.

As used in this description and the claims, the terms “comprises” and “comprising” are intended to be inclusive and mean that the steps and elements that have been specifically identified are not necessarily inclusive and that the method or apparatus may include additional steps or elements. As used herein, the term “and/or” includes any combinations of one or more of the associated listed items.

The indefinite articles “a”, “an”, and “one” preceding an element or ingredient herein are intended to specify, without limitation, the number of instances (i.e., occurrences) of the element or component. Thus, “a”, “an”, and “the” are to be understood to include one or at least one, and the singular word of the element or component also includes the plural.

It should be noted that when a feature is referred to as being “attached” or “connected” to another feature, it can be directly attached or connected to the other feature, or indirectly attached or connected to the other feature, unless specifically stated otherwise. Furthermore, the description of upper, lower, left, right, etc. as used in this disclosure is intended to refer only to the positional relationship of the various elements of the disclosure in the drawings.

It is further understood that the terms “first”, “second”, and the like are used to describe a variety of information, but the information should not be limited to these terms. These terms are only used to distinguish one type of information from another and do not denote a particular order or degree of importance. In practice, the expressions “first”, “second” etc. are completely interchangeable. For example, first information may also be referred to as second information. Similarly, second information may also be referred to as first information, without departing from the scope of the present disclosure.

The above-described embodiments are merely illustrative of the technical concepts and features of the present disclosure, and are provided as preferred embodiments for the purpose of enabling those skilled in the art to understand and practice the present disclosure, and are not intended to limit the scope of the present disclosure.

1-33. (canceled)

34. A child basket comprising:
a seat body;
a handle movably connected with the seat body through a joint;
a safety mechanism connected with the joint;
a locking mechanism comprising a locking member slidably disposed within the joint;
when both the safety mechanism and the locking mechanism are in a locking configuration, the safety mechanism blocks the movement path of the locking member; when the safety mechanism is pushed by an exerted force, the safety mechanism moves away from the movement path of the locking member to enable the locking member to unlock, thereby the handle is rotatable with respect to the seat body around a handle shaft with an axis extending along the left-right direction of the seat body.

35. The child basket according to claim 34, wherein the handle comprising an upper handle bar, a lower handle bar slidably disposed with respect to the upper handle bar and a latching mechanism disposed between the upper handle bar and the lower handle bar to lock the handle in an extended position or a retracted position or unlock the handle to switch between the extended position and the retracted position;
when the latching mechanism is unlocked to enable the upper handle bar slides downwardly with respect to the lower handle bar, the upper handle bar or the lower handle bar pushes against the safety mechanism to move away from the movement path of the locking member to enable the handle to rotate with respect to the seat body around the handle shaft.

36. The child basket according to claim 35, wherein the locking mechanism comprises:
a first engaging member fixedly disposed on the seat body;
a second engaging member fixedly disposed at the lower end portion of the lower handle bar;
the locking member is disposed between the first engaging member and the second engaging member;
an elastic member, wherein the elastic member abuts against the locking member to bias the locking member to slide along the axis of the handle shaft to lock the locking member with respect to both the first engaging member and the second engaging member;
when the locking mechanism is in the locking configuration, the locking member is locked with respect to the first engaging member and the second engaging member respectively; when the locking mechanism is in an unlocking configuration, the locking member is locked with respect to only one of the first engaging member and the second engaging member, and is disengaged from the other one of the first engaging member and the second engaging member; when the locking member is moved, the locking mechanism is switched between the locking configuration and the unlocking configuration.

37. The child basket according to claim 36, wherein the first engaging member is provided with at least one of a first groove radially recessed and extended along the axis of the handle shaft;
the second engaging member is provided with at least one of a second groove radially recessed and extended along the axis of the handle shaft;
the locking member is connected with a button exposed outside of the joint; the locking member is slidably disposed along the axis of the handle shaft, a radially extended protrusion is provided on the locking member, and the protrusion extends along the axis of the handle shaft;
when the locking mechanism is in the locking configuration, the protrusion is inserted into the first groove and the second groove respectively, so that the locking member is simultaneously engaged with the first engaging member and the second engaging member; when the locking mechanism is in the unlocking configuration, the protrusion is disengaged from one of the first groove and the second groove and inserted into the other one of the first groove and the second groove; when the button is pressed to drive the locking member to slide axially, the locking mechanism is switched between the locking configuration and the unlocking configuration.

38. The child basket according to claim 35, wherein the safety mechanism comprising a catch piece, when the upper handle bar slides downwardly with respect to the lower handle bar to a retracted position, the upper handle bar pushes the catch piece away from the movement path of the locking member.

39. The child basket according to claim 35, wherein the latching mechanism comprises a first locking pin and a first locking hole coordinated with the first locking pin, wherein one of the first locking pin and the first locking hole is disposed on the upper handle bar and the other one of the first locking pin and the first locking hole is disposed on the lower handle bar, a first spring is disposed between the first locking pin and the lower handle bar to exert a force biasing the first locking pin to move away from the first locking hole;
a first guiding inclined surface is disposed on a side surface of the seat body to intersect with the axis of the handle shaft;
when the latching mechanism is in the locking configuration, the first locking pin is inserted into the first locking hole; when the latching mechanism is in the unlocking configuration, the first locking pin is disengaged from the first locking hole.

40. The child basket according to claim 39, wherein the sliding direction of the first locking pin is perpendicular to the sliding direction of the upper handle bar with respect to the lower handle bar.

41. The child basket according to claim 40, wherein when the handle switches from a push position to a basket position, the first guiding inclined surface pushes the first locking pin to slide towards the first locking hole.

42. The child basket according to claim 39, wherein a locking plane is disposed on a side of the seat body adjacent to the joint, the axis of the handle shaft is perpendicular to the locking plane, and the first guiding inclined surface intersects with the locking plane;
the handle also has an anti-tilt position and a safety seat position, when the handle is switched between the basket position and the anti-tilt position or the safety seat position, the first locking pin presses against the locking plane and is slidably connected therewith, so that the latching mechanism is maintained in the locking configuration.

43. The child basket according to claim 39, wherein a slider is disposed between the first locking pin and the first guiding inclined surface and slidable along a sliding direction of the upper handle bar with respect to the lower handle bar, the slider is configured to abut against the first guiding inclined surface.

44. The child basket according to claim 43, wherein, the slider is in contact with the first locking pin via a second guiding inclined surface disposed on at least one of the slider and the first locking pin, so that the sliding direction of the slider is perpendicular to the sliding direction of the first locking pin.

45. The child basket according to claim 44, wherein two of the second guiding inclined surfaces are disposed on the slider and the first locking pin respectively and are in face-to-face and sliding contact with each other.

46. The child basket according to claim 44, wherein a circumferential surface is provided on a side of the seat body adjacent to the joint, the handle further comprises an anti-tilt position and a safety seat position; when the handle is switched between the basket position and the anti-tilt position or the safety seat position, the lower end portion of the slider presses against the circumferential surface and is slidably connected therewith; and the upper end portion of the slider continuously presses against the first locking pin to keep the latching mechanism in the locking configuration.

47. The child basket according to claim 43, wherein the latching mechanism comprises:
a second locking pin, wherein the second locking pin is pivotally connected to the upper handle bar via a locking pin shaft;
a second locking hole provided on a side wall of the upper handle bar;
a third locking hole provided on the lower handle bar;
when the handle is switched from the push position to the basket position, the slider pushes the second locking pin upwards so that the second locking pin rotates around the locking pin shaft, thereby the second locking pin moves towards the third locking hole;
when the latching mechanism is in the locking configuration, the second locking pin is inserted into the second locking hole and the third locking hole; the second locking pin is disengaged from the third locking hole when the latching mechanism is in the unlocking configuration; when the latching mechanism is switched between the locking configuration and the unlocking configuration, the second locking pin rotates around the locking pin shaft; and the first spring exerts a force biasing the second locking pin to switch into the unlocking configuration.

48. The child basket according to claim 47, wherein a second spring is disposed between the upper handle bar and the second locking pin and a third spring is disposed between the upper handle bar and the slider.

49. The child basket according to claim 47, wherein a traction device, an unlocking guide block, an insertion hole, a movable portion is disposed in the handle; an unlocking guide block is connected to the traction device, the unlocking guide block is at least partially inserted into an insertion hole, the unlocking guide block is in contact with the movable portion via a third guiding inclined surface; an angle is formed between the third guiding inclined surface and the sliding direction of the first locking pin, at least one of the movable portion and the unlocking guide block is provided with the third guiding inclined surface;
when the latching mechanism is locked, the upper portion of the slider is disposed between the first locking pin and the unlocking guide block; when the slider moves downwards towards the first guiding inclined surface and the traction device pulls the unlocking guide block, the unlocking guide block abuts against the movable portion through the third guiding inclined surface to slide in a direction away from the first locking pin to unlock the latching mechanism.

50. A child basket comprising:
a seat body;
a handle movably connected with the seat body through a joint, the handle comprising an upper handle bar, a lower handle bar slidably disposed with respect to the upper handle bar and a latching mechanism disposed between the upper handle bar and the lower handle bar to lock the handle in an extended position or a retracted position or unlock the handle to switch between the extended position and the retracted position;
a safety mechanism connected with the joint; and
a locking mechanism comprising a locking member slidably disposed within the joint;
when both the safety mechanism and the locking mechanism are in a locking configuration, the safety mechanism blocks the movement path of the locking member; when the latching mechanism is unlocked to enable the upper handle bar slides downwardly with respect to the lower handle bar, the upper handle bar or the lower handle bar pushes against the safety mechanism to move away from the movement path of the locking member to enable the handle to rotate with respect to the seat body around a handle shaft with an axis extending along the left-right direction of the seat body.

51. The child basket according to claim 50, wherein the handle has at least a push position with a first angle with respect to the seat body and a basket position with a second angle with respect to the seat body;
when the handle rotates with respect to the seat body around the handle shaft, the latching mechanism is switched from the unlocking state to the locking state, and the handle is switched from the push position to the basket position.

52. A child stroller, comprising a frame and wheels disposed below the frame, the frame being provided with a child basket, wherein the child basket comprising:
a seat body;
a handle movably connected with the seat body through a joint, the handle comprising an upper handle bar, a lower handle bar slidably disposed with respect to the upper handle bar and a latching mechanism disposed between the upper handle bar and the lower handle bar to lock the handle in an extended position or a retracted position or unlock the handle to switch between the extended position and the retracted position;
a safety mechanism connected with the joint; and
a locking mechanism comprising a locking member slidably disposed within the joint;
when both the safety mechanism and the locking mechanism are in a locking configuration, the safety mechanism blocks the movement path of the locking member; when the latching mechanism is unlocked to enable the upper handle bar slides downwardly with respect to the lower handle bar, the upper handle bar or the lower handle bar pushes against the safety mechanism to move away from the movement path of the locking member to enable the handle to rotate with respect to the seat body around a handle shaft with an axis extending along the left-right direction of the seat body.

53. The child stroller according to claim 52, wherein the child stroller comprising a base, the frame having an unfolded configuration and a folded configuration; and when the frame is in folded configuration, the frame is mounted on the base and the frame is provided with the child basket.
